(19) United States
(12) Patent Application Publication
(10) Pub. No.: US 2026/0347966 A1
(43) Pub. Date: Nov. 5, 2026

(54) PROCESS FOR RECOVERING METAL FROM FEEDSTOCKS

(71) Applicant: MINT INNOVATION LIMITED, Auckland (NZ)

(72) Inventors: David Charles YOUNG, Auckland (NZ); Michelle LAU, Auckland (NZ)

(73) Assignee: MINT INNOVATION LIMITED, Auckland (NZ)

(21) Appl. No.: 19/482,012

(22) PCT Filed: May 8, 2024
(86) PCT No.: PCT/NZ2024/050050

§ 371 Date: Nov. 6, 2025

(30) Foreign Application Priority Data
May 8, 2023 (AU) 2023901375

(51) Int. Cl. C22B 3/44; C22B 3/22; C22B 11/00

(52) U.S. Cl. CPC C22B 3/44; C22B 3/22; C22B 11/04

(57) ABSTRACT

The invention relates to methods for recovering precious metals from feedstocks including urban feedstocks, such as electronic waste and leachates thereof. In particular, selective methods for target metal reduction/binding and recovery of target metals, such as gold, using a support material are provided.

### FIELD OF INVENTION

The invention relates to methods for recovering precious metals from feedstocks including urban feedstocks, such as electronic waste and leachates thereof. In particular, selective methods for target metal reduction/binding are utilised in the recovery methods.

### BACKGROUND

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

There is an abundance of materials containing trace metals throughout the world, including aqueous solutions and solid materials. However, due to the relative scarcity of the metal component relative to the non-metal matrix, recovering these metals in efficient, environmentally safe ways is extremely challenging. For example, the removal of toxic metal ions from aqueous liquid waste streams is a significant challenge for a wide range of industries.

Similarly, as ore grades for the mining and refining of virgin metals decrease, increased interest is being shown in obtaining metals from sources such as low-grade mining ores, smelter tailings, electronic waste, and automotive catalytic converters. Recovering metals from these feedstocks, however, is often economically prohibitive. Factors that influence the viability of any recovery process include the metal concentration of a feedstock (and hence the amount of feedstock required for processing); the presence of impurities such as other metals or refractory materials; and the volume of effluent generated. There is therefore a place for alternative solutions that aim to mitigate at least some of these problems, thereby improving the economics for the recovery of metals from low-grade or recalcitrant feedstocks.

Traditional techniques for refining metals include pyrometallurgy and hydrometallurgy. In pyrometallurgy, a feedstock is smelted at high temperature (typically in the presence of a suitable reductant and/or catalyst). This requires a non-trivial energy input (and associated emissions), and therefore there is a practical minimum metal concentration required in a feedstock. In hydrometallurgy, the feedstock is treated with a lixiviant solution that leaches the desired metal (specifically or otherwise) into an ionic or complexed soluble form. Subsequent steps are required to recover the target metal(s) from solution (e.g. electrowinning). Due to practical considerations related to efficient mixing of a solid in a liquid, particularly at commercially-relevant scale, a set solid/liquid ratio is generally used for hydrometallurgical processes. This means that a lower concentration of target metal in the feedstock results in more dilute target metal solutions, and that the concentration of target metal in the leachate is less than that in the solid feedstock. Depending on the temperature and pressure requirements for leaching, this approach may allow for lower grade feedstocks to be processed in comparison to pyrometallurgy. Consideration needs to be made for the possible use of corrosive (e.g. acidic) or toxic (e.g. cyanide) solutions; any consumption of solution components during feedstock treatment; and dealing suitably with waste effluent. Pyrometallurgy and hydrometallurgy techniques are not mutually exclusive, and may be used sequentially over multiple steps to refine specific metals.

Recovery of gold from gold containing ores is a typical example of a hydrometallurgical approach that has a number of issues. The amount of gold in gold bearing ores has been declining for over a hundred years as easier to recover resources with higher gold content have been depleted through extensive mining. As such, hydrometallurgical techniques have been used to recover traces of gold from large volumes of rock. Cyanide-based lixiviants have been successfully employed for many years, but suffer from toxicity issues and challenges with processing certain ore types.

Waste electrical and electronic equipment (e-waste), such as printed circuit boards from computers, cell phones, notebooks and LCD displays, represent a large target for metal recovery systems. Waste electrical and electronic equipment are an example of an urban precious metal feedstock. Approximately 53.6 million tonnes of electronic waste were generated worldwide in 2019, with global generation of e-waste projected to grow to 74.7 Mt by 2030 (Forti et al, The Global E-waste Monitor 2020, United Nations University, UN-ITR, ITU, ISWA, (2020)). On a per weight basis, this e-waste contains high amounts of valuable base and precious metals (including gold) in comparison to virgin ore. Recovering metals from this feedstock is attractive because the mining and refining processes used to obtain virgin metals consumes energy and water resources (and generates related carbon emissions); recycling means that these costs need not be borne again. As an example, recycling copper reportedly requires 85% less energy than producing virgin material from ore (Khaliq et al, Resources 3, pp 152-179 (2014)).

While much endeavour has been applied to recovering precious metals such as gold from e-waste using pyrometallurgy and hydrometallurgy approaches, sustainable success has yet to be achieved. Pyrometallurgy approaches commonly involve incinerating circuit boards to liberate and fractionate metals—this is energy and capital intensive, and produces dangerous gases such as dioxins. Hydrometallurgy approaches commonly involve using strong acids or cyanide-based solutions to leach metals—this is highly toxic, expensive and can be non-recyclable. The heterogeneity of e-waste as a feedstock also makes it difficult to economically apply these existing technologies.

Automotive catalytic converters are a second example of a precious metal feedstock, containing significant quantities of precious metals such as palladium, platinum and rhodium, in greater concentration than in virgin ores (Xu et al, Environ. Sci. Technol. 53, pp 733-742 (2019)). Energy intensive pyrometallurgical methods are currently employed to recycle these materials.

Accordingly, there remains a need for cost effective and energy efficient methods of recovering metals from these and other feedstocks, and particularly such methods having minimised environmental impact.

It is an object of the present invention to provide a method of recovering precious metals from hydrometallurgical leachates derived from feedstocks such as electronic waste, ore and/or catalytic converters using selective reductive/adsorptive techniques that complement or replace traditional pyrometallurgy and hydrometallurgy approaches, or to at least provide the public with a useful choice in this regard. It is anticipated that this will lead to the capture of value from low-grade or waste streams of metal that are currently neglected, and/or provide for lower cost, energy efficient and/or environmentally sound alternatives to existing approaches.

### SUMMARY OF THE INVENTION

The present invention responds to a need in the art. The present invention relates to methods for recovering precious metals (target-metals) from precious metal feedstocks, such as but not limited feedstocks including virgin and reworked ores including tailings, electronic waste and automotive catalytic converters. In particularly contemplated examples, the invention leaves the composition of non-target metals substantially unchanged.

The invention generally relates to methods of recovering one or more target metals from a leachate containing a target metal or target metals (referred to herein as a pregnant solution) selectively over other metals that are present in solution. This leaves a barren solution containing lower, and in particularly contemplated examples essentially no or no target metal(s), but in which the concentration of non-target metals is substantially unaffected or is unaffected. In various examples, the concentration of the one or more target metal in the pregnant solution may be higher, broadly equivalent to, lower or even significantly lower than the concentration of non-target metals. The one or more target metals are concentrated on a biomass-derived support material which is then recovered, for example by physically separating it from the barren solution by conventional solid-liquid separation techniques. The target metal-laden support material removed from solution is also referred to herein as a target metal concentrate. In various examples, the methods disclosed herein are capable of concentrating one or more target metals to a substantial degree, such that the one or more target metals are concentrated to the support material by a concentration factor of about 10 to 1000 or more, relative to its concentration in solution, in addition to being physically separated from other metals. The methods result in the production of a metal laden support material that is amenable to further processing, for example repeated use in the methods discussed here, or still further concentration for example by pyrometallurgical manipulation. Accordingly, the overall concentration factor achievable using the methods discussed herein coupled with established refinement techniques, for example concentration and recovery methods such as pyrometallurgical processing, in certain examples will be about 10,000 to about 100,000 or more.

In various examples, the methods disclosed herein comprise a two-step approach where the target metal (and any non-target metals) are leached from the solid material into solution and the solid residue is then removed from solution by solid-liquid separation techniques known to those familiar with the art. In a second step, the pregnant solution is then contacted with a support material and a reductant to load only the target metal on the support. This contrasts existing techniques for gold recovery from ore which utilise a single step carbon in pulp (CIP) method in which a porous activated carbon material is included in the leach step and separated from the ore by a difference in the particle size.

Accordingly, in a first aspect, the invention relates to a method for selectively binding a target metal to a support material, wherein the method comprises
a) adding the support material to a solution containing dissolved ions of target metal; and
b) reducing the target metal ion such that the target metal binds to the support material using an amount of reducing agent with a reducing potential high/low enough to reduce target metal ion to target metal but not high/low enough to reduce non-target metal;
c) separating the support material from the solution; and
d) recovering the target metal from the support material.

In a further aspect, the invention relates to a method of recovering one or more target metals from a solution, wherein the solution comprises dissolved metal ions of at least one target metal and dissolved metal ions of at least one non-target metal, the method comprising:
a) adding to the solution a support material and a reducing agent, wherein the reducing agent has a reducing potential effective to reduce at least one species of target metal ions to target metal but ineffective to reduce at least one species of non-target metal ions; and
b) maintaining the solution for a time and under conditions suitable to bind the at least one target metal to the support material to form a target metal-laden support material; and
c) separating the metal-laden support material from the solution; and
d) recovering the at least one target metal from the target metal-laden support material.

In a further aspect, the invention relates to a method of recovering one or more target metals from a solution, wherein the solution comprises dissolved metal ions of at least one target metal and dissolved metal ions of at least one non-target metal, the method comprising:
a) adding to the solution a support material and a reducing agent, wherein the reducing agent has a reducing potential effective to reduce at least one species of non-target metal, and wherein the reducing agent is added in an amount insufficient to reduce all of said at least one species of non-target metal ions; and
b) maintaining the solution for a time and under conditions suitable to reduce the at least one target metal ions and to bind the at least one target metal to the support material to form a target metal-laden support material; and
c) separating the target metal-laden support material from the solution; and
d) recovering the at least one target metal from the target metal-laden support material.

Any of the examples described herein can relate to any of the aspects presented herein.

In one example, the solution is formed by dissolution of a solid feedstock.

In various examples, the addition of support material to the solution precedes the addition of reducing agent by a time sufficient to allow for dispersal of the support material in the solution.

In one example, the addition of reducing agent to the solution precedes the addition of support material.

In various examples, the reducing agent has a reducing potential effective to reduce only one species of metal ions present in the solution to metal.

In various examples, the reducing agent has a reducing potential effective to reduce only one species of the target metal ions present in the solution to target metal.

In various examples, the reducing agent has a reducing potential effective to reduce only one species of the target metal ions present in the solution to target metal and ineffective in reducing all species of non-target metal ions present in the solution.

In various examples, the reducing agent has a reducing potential effective to reduce at least one species of target metal ions present in the solution to target metal, but ineffective to reduce all species of non-target metal ions.

In various examples, the method comprises after step b) the additional step of adding to the solution another reducing agent having a reducing potential effective to reduce at least one species of target metal ions still present in the solution to target metal.

In various examples, the method comprises after step b) the additional step of adding to the solution another reducing agent having a reducing potential effective to reduce at least one species of target metal ions still present in solution to target metal, but ineffective to reduce at least one species of non-target metal ions.

In one example, the reducing agent has a reducing potential effective to reduce at least one species of non-target metal ions present in the solution, and is added in an amount insufficient to reduce all of the non-target metal ions present.

In one example, the reducing agent has a reducing potential effective to reduce at least one species of non-target metal ions present in the solution, but ineffective to reduce all species of non-target metal ions.

In one example, the reducing agent has a reducing potential effective to reduce all species of non-target metal ions present in the solution to target metal, and is added in an amount insufficient to reduce all of the non-target metal ions present.

In various examples, the method comprises after step b) the additional step of separating the target metal laden support material from the solution and adding the support material to a solution and reducing agent as set out in step (a).

In one example, the target metal-laden support material is separated from the solution by filtration.

In one example, the support material comprises, consists essentially of, or consists of cellulose or a cellulosic material.

In various examples, the reducing agent is selected from the group consisting of organic acids, hydrazines, hydrides, borohydrides, and inorganic acids.

In one example, the reducing agent comprises, consists essentially of, or consists of one or more organic acids. In one example, the reducing agent comprises, consists essentially of, or consists of formic acid.

In one example, the reducing agent comprises an inorganic acid.

In various examples, the reducing agent is selected from the group consisting of ascorbic acid or a salt thereof, citric acid or a salt thereof, formic acid or a salt thereof, lactic acid or a salt thereof, malic acid or a salt thereof, oxalic acid or a salt thereof, tartaric acid or a salt thereof, and uric acid or a salt thereof.

In one example, the one of the target metals is selected from the group consisting of gold, palladium, platinum, and rhodium.

In one example, the one of the target metals is gold.

In one example, when one of the species of target metal ions is gold, the reducing agent is ascorbic acid or a salt thereof.

In various examples, the method comprises the preliminary step of pre-processing the solid feedstock.

In one example, the solution is an aqueous solution containing more than 10 ppm of the target metal.

In one example, the barren aqueous solution contains less than 1 ppm of the target metal.

In one example, at least about 90% of the target metal is bound to the support material and/or recovered.

In one example, at least about 95%, or at least about 99%, of the target metal is bound to the support material and/or recovered.

In one example, the concentration factor of the target metal from the pregnant aqueous solution to the support material is greater than 100.

In various examples, the concentration factor of the target metal from the pregnant aqueous solution to the support material is greater than 1000.

In various examples, in the maintaining step the support material is in contact with the pregnant aqueous solution for between about 0.5 and 48 hours.

In various examples, the recovery step comprises burning of the metal laden support material or chemical dissolution of the target metal/support material complex to release the target metal.

In various examples, the pregnant solution comprises at least one further metal and the reducing agent preferentially reduces the target metal over the further metal, and the further metal(s) remains in the barren solution in the separating step.

In various examples, the target metal is bound to the support material over the further metal in the binding step such that the mass ratio of target metal to further metal on the support material increases by a factor of at least 2 when compared to the mass ratio in the pregnant solution.

In one example, the further metal is selected from one or more of copper and nickel.

In one example, the solid feedstock comprises a solid material comprising less than 5% of target metal.

In various examples, the solid feedstock is selected from the group consisting of an ore, a tailing, or e-waste.

In one example, the target metal is gold and the solid feedstock material is selected from the group consisting of e-waste, gold bearing ore, gold bearing sand, gold bearing clay and a combination of any two or more thereof.

In one examples, the solution is formed by dissolution of a solid feedstock in a lixiviant.

In various examples, the lixiviant solution is a thiourea-based solution, or a thiosulphate-based solution, or a thiocyanate-based solution, or a cyanide-based solution, or a halogen-based solution, or an aqua regia-based solution.

In one example, the pH of the solution prior to the recovery step is maintained within the range of from about 3 to about 10.

In various examples, at least a portion of the support material and/or the barren solution is reused in a further repeat of the method.

In various examples, one or more additional components are added to the barren solution such that it can act as a lixiviant.

In various examples, the one or more additional components are selected from one or more of thiourea, thiosulphate, thiocyanate, cyanide, a halogen, nitric acid, hydrochloric acid.

In one example, the barren solution is treated with chlorine gas.

In various example, at least 25% of the barren solution is reused.

In various examples, the method comprises a preliminary pre-processing step selected from the group consisting of chip removal; grinding, for example grinding to a preselected size; removal of certain density fractions; removal of one or more magnetic materials; a base metal leach; and any combination of two or more thereof.

In various examples, the pre-processing step removes at least a portion of non-target material from the feedstock.

In various examples, the non-target material includes one or more base metal(s).

In a further aspect, the invention relates to a method of preparing a target metal laden cellulose material, the method comprising:
a) adding to a solution comprising dissolved metal ions of at least one target metal and dissolved metal ions of at least one non-target metal a filterable cellulose material and a reducing agent, wherein the reducing agent has a reducing potential effective to reduce at least one species of target metal ions to target metal but ineffective to reduce at least one species of non-target metal ions; and
b) maintaining the solution for a time and under conditions suitable to precipitate the at least one target metal to the cellulose material to form a target metal-laden cellulose material; and
c) separating the metal-laden cellulose material from the solution by filtration; and
d) recovering the target metal-laden cellulose material.

In various examples, the target metal is gold.

In a further aspect, the invention relates to a metal laden cellulose material prepared by the method as claimed in any preceding claim.

In one example of the metal laden cellulose material of the invention, the metal is gold.

In one example of the gold laden cellulose material of the invention, the gold is gold nanoparticles.

In a particularly contemplated example, the target metal is a noble metal. For example, the target metal is a noble metal selected from the group consisting of gold, silver, mercury, rhenium, ruthenium, rhodium, palladium, osmium, iridium, and platinum. In one example, the target metal is selected from the group consisting of gold, silver, ruthenium, rhodium, palladium, osmium, iridium, and platinum.

In another particularly contemplated example, the target metal is a platinum group metal selected from the group consisting of ruthenium, rhodium, palladium, osmium, iridium, and platinum.

In a particularly contemplated example, the target metal is selected from the group consisting of gold, silver, platinum and palladium.

In various examples, the non-target metal is a metal present in the feedstock or leachate other than a target metal. For example, non-target metals commonly present in e-waste include Al, Cr, Cu, Fe, Mn, Ni, Pb, Sn, Zn. For example, non-target metals commonly present in catalytic converters include Al, Cr, Fe, Mn, Ni, and rare earth elements. Accordingly, in various examples the non-target metal is selected from the group consisting of Al, Cr, Cu, Fe, Mn, Ni, Pb, Sn, Zn, rare earth elements, and any combination of two or more thereof.

In one example the pregnant solution contains between about 0.1 ppm to 1500 ppm, or between about 0.1 ppm to 1000 ppm, or between about 0.1 ppm to 500 ppm, or between about 0.1 ppm to 200 ppm, or between about 0.1 ppm to 100 ppm, or between about 0.1 ppm to 50 ppm, or between about 0.1 ppm to 20 ppm of the target metal. In one example the pregnant solution contains between about 0.5 ppm to 1500 ppm, or between about 0.5 ppm to 1000 ppm, or between about 0.5 ppm to 500 ppm, or between about 0.5 ppm to 200 ppm, or between about 0.5 ppm to 100 ppm, or between about 0.5 ppm to 50 ppm, or between about 0.5 ppm to 20 ppm of the target metal(s). In one example the pregnant solution contains between about 1 ppm to 1500 ppm, or between about 1 ppm to 1000 ppm, or between about 1 ppm to 500 ppm, or between about 1 ppm to 200 ppm, or between about 1 ppm to 100 ppm, or between about 1 ppm to 50 ppm, or between about 1 ppm to 20 ppm of the target metal(s).

In one example the barren solution contains less than 0.1 ppm, or less than 1 ppm, or less than 2 ppm, or less than 5 ppm, or less than 10 ppm, or less than 20 ppm, or less than 50 ppm, or less than 100 ppm of the target metal. In one example the barren solution contains between about 0.001 and 100 ppm, or between about 0.001 and 50 ppm, or between about 0.001 and 50 ppm, or between about 0.01 and 50 ppm of the target metal(s).

In one example the pregnant solution contains at least 10 times more target metal than the barren solution. In one example the pregnant solution contains at least 20 times, or at least 40 times, or at least 45 times or at least 50 times more target metal than the barren solution.

In one example the metal laden support material comprises greater than 100 ppm, greater than 200 ppm, greater than 500 ppm, or greater than 1000 ppm of the target metal(s).

In one example the metal laden support material comprises greater than 2000 ppm, greater than 3000 ppm, greater than 4000 ppm, greater than 5000 ppm, greater than 6000 ppm, greater than 7000 ppm, greater than 8000 ppm, greater than 9000 ppm, greater than 10000 ppm, greater than 15000 ppm, greater than 20000 ppm, greater than 25000 ppm, or greater than 30000 ppm of the target metal(s).

In one example the metal laden support material comprises greater than 0.1% (w/w) target metal(s), for example greater than 0.2% (w/w), greater than 0.3% (w/w), greater than 0.4% (w/w), greater than 0.5% (w/w), greater than 0.6% (w/w), greater than 0.7% (w/w), greater than 0.8% (w/w), greater than 0.9% (w/w), or greater than 1% (w/w) target metal(s).

In one example the metal laden support material comprises greater than 1.5% (w/w) target metal(s), for example greater than 2% (w/w), greater than 3% (w/w), greater than 4% (w/w), greater than 5% (w/w), greater than 6% (w/w), greater than 7% (w/w), greater than 8% (w/w), greater than 9% (w/w), or greater than 10% (w/w) target metal(s).

In a particular example, the pregnant solution includes at least one further metal, in addition to the one or more target metal(s). In one example the reducing agent preferentially reduces the one or more target metal(s) over the further metal, facilitating the binding of target metal(s) to the support material, such that the further metal remains in the barren solution at the separating step.

In one example the binding of the target metal(s) over the further metal is such that the mass ratio of target metal(s) to further metal on the support material increases by a factor of at least 2 when compared to the mass ratio of the metals in the pregnant solution. In one example the mass ratio increased by a factor of at least 3, or at least 5, or at least 8, or at least 10, or at least 20, or at least 50, or at least 100, or at least 200. In one example the target metal is gold, palladium, platinum, or rhodium. In one example the further metal is selected from one or more of copper and nickel.

In one example the concentration factor of the target metal from the pregnant solution to the support material is greater than 5 or greater than 10, or greater than 20, or greater than 50, or greater than 100, greater than 200, greater than 300, greater than 400, greater than 500, greater than 600, greater than 700, greater than 800, greater than 900, or greater than 1000.

In one example the concentration factor of the target metal from the pregnant solution to the support material is greater than 1500, greater than 2000, greater than 3000, greater than 4000, greater than 5000, greater than 6000, greater than 7000, greater than 8000, greater than 9000, greater than 10000, greater than 15000, greater than 20000, greater than 25000, or greater than 30000.

In one example, in the binding step the support material is in contact with the pregnant solution for between about 0.5 and 48 hours. In one example between about 0.5 and 24 hours, or between about 0.5 and 12 hours, or between about 0.5 and 4 hours, or between about 1 and 3 hours.

In one example the binding step is carried out at ambient temperature, for example between about 15 and 35 °C. In other examples, the binding step is carried out at temperatures above ambient, for example above about 35 °C.

In one example where the target metal is gold the support material is selected from the group consisting of cellulose, modified cellulose, and cellulosic materials.

In one example where the target metal is gold the support material comprises cellulose.

In various examples, the cellulosic material is selected from the group consisting of wood, wood chips, sawdust, wood pulp, kraft pulp, and paper.

In certain examples, the separation step includes at least one of: gravity separation of the metal laden support material from the barren solution and removal of the barren solution; centrifugation and removal of the barren solution; and filtration of the metal laden support material from the barren solution.

In certain examples, the separating step comprises separating the metal laden support material by filtration, wherein during the filtration at least 50% of the barren solution is removed from the metal laden support material. In one example at least 60%, or at least 70%, or at least of 80%, or at least 90%, or at least 95% of the barren solution is removed during filtration.

In certain examples, particularly in examples where filters with a larger pore size are used, yield will be improved by recirculation or re-filtering the filtrate, and particularly the early filtrate such as the first 5% or 10% of the filtrate, to capture smaller particles of the support material. As those skilled in the art will recognise, a balance between speed and a high proportion of collection will usually need to be reached to maximise process efficiency, though this may depend on various factors including the targeted yield, the feedstock, the target metals, and the like.

In certain examples, the separating step comprises gravity separation of the metal laden support material from the barren solution, wherein at least 50% of the barren solution is removed. In one example at least 60%, or at least 70%, or at least of 80%, or at least 90%, or at least 95% of the barren solution is removed.

In certain examples, the separating step comprises separating the metal laden support material by centrifugation, wherein during the centrifugation at least 50% of the barren solution is removed from the metal laden support material. In one example at least 60%, or at least 70%, or at least of 80%, or at least 90%, or at least 95% of the barren solution is removed during centrifugation.

In certain examples, the separation steps includes filtration and at least one of gravity separation and centrifugation.

In certain examples the separating step includes drying the support material.

In certain examples the lixiviant dissolves at least 50%, or at least 60%, or at least 70%, or at least 80%, or at least 90% of the target metal(s) from the precious metal feedstock. In particular examples, the lixiviant dissolves 95-99.5% of the target metal(s).

In certain examples the lixiviant solution is a thiourea-based aqueous solution, or a thiosulphate-based aqueous solution, or a thiocyanate-based aqueous solution, or a cyanide-based aqueous solution, or a halogen-based aqueous solution, or an aqua regia-based solution. In particular examples, the lixiviant comprises a chloride source and an oxidant. In particular examples, the lixiviant comprises a water miscible solvent, an oxidant and an acid—as specified by Foley et al in WO2016/168933 (incorporated herein by reference). In particular examples, the lixiviant comprises a halogen solution, or an acetic acid and chlorine, or hydrochloric acid and peroxide. In particular examples the target metal undergoes a ligand exchange step between extraction and binding to the support material.

In certain examples, the method comprises one or more steps preliminary to target metal extraction, such as a pre-processing step. Accordingly, in one example the method of recovering one or more target metals from precious metal feedstock comprises:
(a) a pre-processing step comprising one or more operations selected from the group consisting of chip removal; grinding, for example grinding to a preselected minimum or maximum size; removal of certain density fractions; removal of one or more magnetic materials; and a base metal leach; and/or
(b) a dissolving step comprising contacting precious metal feedstock (including a pre-processed feedstock such as a feedstock pre-processed according to (a) above) with a lixiviant such that at least a portion of the target metals dissolve into the lixiviant to produce a pregnant solution; and/or
(c) a ligand exchange step, converting the dissolved target metal ions in the pregnant solution to a target metal ion species or complex that is more suitable for one or more of the subsequent steps.

In certain examples, selectivity for the target metal(s) is improved by removing at least a portion of non-target materials prior to the dissolving step. In particular examples, the method includes a pre-processing step wherein at least a portion of non-target materials are removed prior to the dissolving step.

In particular examples the pre-processing step comprising one or more operations including but not limited to: chip removal; grinding to a preselected maximum size; removal of certain density fractions; removal of magnetic material; and/or base metal leach.

In particular examples, the pre-processing step includes at least one of the above operations. In another example, the pre-processing step includes at least two of the above unit operations. In another example the pre-processing step includes at least three of the above unit operations. In another example, the pre-processing step includes at least four of the above unit operations.

In particular examples the pre-processing step removes at least 50% of the non-target materials prior to the precious metal recovery, or at least 60%, or at least 70%, or at least 80%, or at least 90%, or at least 95%. In particular preferred examples, the pre-processing step removes less than 20%, or less than 10%, or less than 5%, or less than 2%, or less than 1% of the target metal(s).

In one example the feedstock is electronic waste comprising, consisting essentially of, of consisting of printed circuit boards (PCBs). In one example the PCBs comprise at least 10 ppm, or at least 20 ppm, or at least 50 ppm, or at least 100 ppm, or at least 200 ppm, or at least 300 ppm, or at least 400 ppm, or at least 500 ppm target metal. Since PCBs contain a plurality of metals including base metals, precious metals and target metals, it is recognised there is substantial benefit in using a lixiviant that dissolves the target metal selectively over other non-target metals. However, since precious metals are typically less reactive than base metals it is recognised that selectivity of dissolution may be low.

Hence, the methods disclosed herein enable the selective reduction and binding of desired target metals through the use of selected reducing agents.

In one example, the target metal(s) and non-target materials are substantially selectively reduced by the reducing agent in a ratio of greater than 1:1000 (target metal:non-target material), or greater than 1:500, or greater than 1:200, or greater than 1:100, or greater than 1:50, or greater than 1:20, or greater than 1:10, or greater than 1:5, or greater than 1:2, or greater than 1:1.

In one example, the target metal(s) and non-target materials are substantially selectively dissolved by the lixiviant in a ratio of greater than 1:1000 (target metal:non-target material), or greater than 1:500, or greater than 1:200, or greater than 1:100, or greater than 1:50, or greater than 1:20, or greater than 1:10, or greater than 1:5, or greater than 1:2, or greater than 1:1.

In particular examples, the invention comprises at least a partially selective reducing step and an at least partially selective dissolving step. In other examples, the method includes a pre-processing step to remove at least a portion of the non-target materials and at least a partially selective dissolving step.

In particularly contemplated examples the target metal is gold.

In various examples, the reducing agent is selected from the group comprising ascorbic acid, hydrazine sulfate, citric acid, and sodium borohydride, and any combination of two or more thereof.

In particular examples, the reducing agent comprises, consists essentially of, or consists of ascorbic acid. In particular examples, the lixiviant comprises, consists essentially of, or consists of acetic acid.

In another example, for example where target metal(s) and non target materials are dissolved non-selectively (i.e., all metals are dissolved), the support materials may selectively binds the target metal(s). In particular examples the target metal(s) and non target materials are bound by the support materials in a ratio of at least 1:1 (target metal:non-target metal), or at least 5:1, or at least 10:1, or at least 20:1, or at least 50:1 or at least 100:1, or at least 200:1, or at least 500:1, or at least 1000:1, or at least 5000:1, or at least 10000:1. In particular examples, the support materials bind target metal and substantially no non-target metal.

In certain examples, the steps of the method prior to the recovery step are each performed in the same vessel. In one example, the addition and maintaining steps are performed in the same vessel.

An additional separation step may be required to separate the metal laden support material from the barren solution and remaining solid feedstock material.

In various examples the method further includes a recycling step wherein at least a portion of the support material is reused, for example, reused in a further binding step.

In one example the method further includes a recycling step wherein at least a portion of barren solution is reused as lixiviant or partially used as lixiviant in a dissolving step.

It is appreciated that in certain examples the barren solution contains metal ions and in some instances may even include limited target metal ions. Accordingly, in some examples the barren solution is treated to remove excess metal ions or other compounds prior to reuse, such as prior to returning it for use in a dissolving step. In some examples, at least a portion of the barren solution is mixed with makeup water prior to returning to a dissolving step.

It is further recognised that, where lixiviant is to be reused, one or more additional components may need to be added to the barren solution such that it can act as a lixiviant and dissolve target metal(s).

For example, in certain examples where the lixiviant is thiosulfate or cyanide or thiourea or chlorine, the active lixiviant agent(s) is at least partially recharged to enable further dissolution of the target metal(s). In certain examples, these additional components are added to the barren solution prior to returning to a dissolving step. By way of non-limiting example, additional oxidant and/or additional acid or base and/or additional counter ion is added. Additionally or alternatively, the barren solution is treated to adjust the pH, the ORP, the temperature or any other physical properties that might be known to those skilled in the art in order to make it a suitable lixiviant.

In particular examples, at least 25% of the barren solution is reused, for example is returned to a dissolving step. In other examples, at least 35%, or at least 45%, or at least 55%, or at least 65%, or at least 75%, or at least 85%, or at least 95% of the barren solutions is returned to a dissolving step.

In another example, the invention further includes the step of recovering the target metal(s) from the metal laden support materials. In certain examples, the recovery step includes contacting the metal laden support material with a condition which triggers the release of the target metal(s), such as the release of substantially all of the target metal(s), from the support material.

In one example, the condition is a solution containing a compound that triggers release of the target metal. In one example, the release solution contains one or more of a compound that releases the target metal(s) from the support material. In one example, the release solution contains cysteine, or thiosulphate, thiourea, hydrochloric acid, oxidant, oxidant and halide source, or aqua regia. In certain examples, the support material is re-used in whole, in significant part or in part with fresh support material. Additionally or alternatively, the condition triggers release of the target metal. By way of example, the release solution comprises conditions that trigger the release of the target metal(s) or metal ions. By way of example, the conditions may be of pH less than 5, or pH less than 4, or pH less than 3, or pH less than 2. Alternatively, the conditions may be between pH 1 and 5, or between pH 2 and 5, or between 2 and 4. By way of further example, the conditions may be pH greater than 8, or pH greater than 9, or pH greater than 10, or pH greater than 11, or pH greater than 12. Alternatively, the pH may be between pH 8 and 13, or between pH 9 and 13, or between 10 and 13. Additionally or alternatively, the conditions may be at an oxidation-reduction potential suitable for release of the target metal(s).

Alternatively, the recovery step includes burning or chemical dissolution of the metal laden support material to release the target metal(s).

In particular examples, the target metal(s) is gold, palladium, platinum or rhodium.

In certain examples the feedstock is an urban precious metal feedstock comprising a solid material comprising about 10%, less than about 10%, about 5%, less than about 5%, about 1%, less than about 1%, or less than 0.1%, or less than 0.01%, or less than 0.001%, or less than 0.0001% of target metal.

In certain examples where the target metal is gold, preferably the solid feedstock material is e-waste, or gold bearing ore, or gold bearing sand, or gold bearing clay.

In certain examples where the target metal is palladium, preferably the solid feedstock material is e-waste, or automotive catalytic converters, or industrial catalysts, or fine chemical catalysts, or palladium bearing ore, or palladium bearing sand, or palladium bearing clay.

In certain examples where the target metal is platinum, preferably the solid feedstock material is e-waste, or automotive catalytic converters, or industrial catalysts, or fine chemical catalysts, or platinum bearing ore, or platinum bearing sand, or platinum bearing clay.

In certain examples where the target metal is rhodium, preferably the solid feedstock material is e-waste, or automotive catalytic converters, or rhodium bearing ore, or rhodium bearing sand, or rhodium bearing clay.

In another aspect, there is provided a system for the recovery of target metal from electronic waste, the system comprising:
(a) optionally a vessel configured for contacting electronic waste with a lixiviant such that at least a portion of one or more target metal(s) dissolve to produce a pregnant solution;
(b) optionally, a vessel configured for contacting the pregnant solution with a ligand exchange solution to converting at least some of the dissolved target metal complex into a target metal complex that is more suitable for one or more of the subsequent steps;
(c) a vessel configured for contacting a support material with the pregnant solution in the presence of a reducing agent having a reducing potential effective to reduce at least one species of target metal ions to target metal but ineffective to reduce at least one species of non-target metal ions such that at least a portion of the target metal(s) bind to the support material, wherein the support material becomes metal laden, and the pregnant solution becomes barren;
(d) a separator configured for substantially separating the metal laden support material from the barren solution; and
(e) optionally, a recovery module configured for recovery of the target metal(s) from the metal laden support material.

In certain examples, the system includes one or more conduits for passing the pregnant solution from the vessel in (a) to the vessel in (c). In certain examples, the vessel in (a) is the same as or part of the vessel in (b), and/or is the same as or part of the vessel in (c). In another example, the system includes one or more conduits for passing the barren solution containing metal laden support material from the vessel in (c) to the separator (d). In certain examples, the system includes one or more conduits for passing the separated metal laden support material in (d) to the recovery module in (e).

In certain examples, the method comprises an optional ligand exchange step. In certain examples, the optional ligand exchange step is performed in the same vessel as step (a), for example by introducing a chloride source and optionally an oxidant into the vessel.

The separator is configured for separating the metal laden support materials by filtration, wherein at least a portion of the barren solution is removed from the metal laden support material.

In certain examples, in addition to at least some filtration, the separator is configured for gravity separating the metal laden support material from the barren solution wherein at least a portion of the barren solution is removed from the metal laden support material.

In certain examples, in addition to at least some filtration, the separator is configured for separating the metal laden support materials by centrifugation, wherein at least a portion of the barren solution is removed from the metal laden support material; In certain examples, the recovery module includes an element for contacting the metal laden support material with a solution.

In certain examples, the recovery module includes an element for burning the metal laden support material to release the target metal.

In particular examples, the system includes pre-processing configured to remove at least a portion of the non-target material prior to passing to the dissolution vessel.

In one example the pre-processing comprises one or more operations including but not limited to: chip removal; grinding to a preselected maximum size; removal of certain density fractions; removal of magnetic material; and/or base metal leach.

In particular examples, the pre-processing (also referred to herein as the pre-processing step) includes at least one of the above operations. In another example, the pre-processing step includes at least two of the above operations. In another example the pre-processing step includes at least three of the above operations. In another example, the pre-processing step includes at least four of the above operations.

In particular examples the pre-processing step removes at least 50% of the non-target materials prior to the precious metal recovery, or at least 60%, or at least 70%, or at least 80%, or at least 90%, or at least 95%. In particular preferred examples, the pre-processing step removes less than 20%, or less than 10%, or less than 5%, or less than 2%, or less than 1% of the target metal(s).

In particular examples of various aspects disclosed herein, the support materials comprises, consists essentially of, or consists of cellulose.

Additionally or alternatively, a mixture of support material species may be used. In various examples, where a mixture of support materials is used, at least one of the support materials is cellulose.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

To those skilled in the art to which the invention relates, many changes in construction and widely differing examples and applications of the invention will suggest themselves without departing from the scope of the invention as defined in the appended claims. The disclosures and the descriptions herein are purely illustrative and are not intended to be in any sense limiting.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7). These are only examples of what is specifically intended and all possible combinations of numerical values between the lowest value and the highest value enumerated are to be considered to be expressly stated in this application in a similar manner.

Those skilled in the art will appreciate the meaning of various terms of degree used herein. For example, as used herein in the context of referring to an amount (e.g., “about 9%”), the term “about” represents an amount close to and including the stated amount that still performs a desired function or achieves a desired result, e.g. “about 9%” can include 9% and amounts close to 9% that still perform a desired function or achieve a desired result. For example, the term “about” can refer to an amount that is within less than 10% of, within less than 5% of, within less than 1% of, within less than 0.1% of, or within less than 0.01% of the stated amount. It is also intended that where the term “about” is used, for example with reference to a figure, concentration, amount, integer or value, the exact figure, concentration, amount, integer or value is also specifically contemplated.

Other objects, aspects, features and advantages of the present invention will become apparent from the following description. It should be understood, however, that the detailed description and the specific examples, while indicating preferred examples of the invention, are given by way of illustration only, since various changes and modifications within the spirit and scope of the invention will become apparent to those skilled in the art from this detailed description.

### BRIEF DESCRIPTION OF THE FIGURES

These and other aspects of the present invention, which should be considered in all its novel aspects, will become apparent from the following description and non limiting examples, which is given by way of example only, with reference to the accompanying figures, in which:

FIG. 1 presents five photographs of filter pads comprising different amounts of support material recovered following binding of target metals, as described herein in Example 4, in which: B is sample 25-B; C is sample 25-C; D is sample 25-D; 24-C is sample 24-C; and E is sample 25-E.

FIG. 2 presents a diagram depicting the reuse of support material and reiterative recovery of target metal from solution, as described in Example 6 herein. The concentration of gold in solution is shown in the various samples as follows: 0. Fresh Au solution (27.1 ppm Au); 1. After CFA and ascorbic acid added and sample centrifuged; 2. Filtrate of 1; 3. Fresh Au solution (27.1 ppm Au) added to CFA (1× used) recovered from 1; 4. After ascorbic acid added and sample centrifuged; 5. Filtrate of 4; 6. Fresh Au solution (27.1 ppm Au) added to CFA (2× used) recovered from 4; 7. After ascorbic acid added and sample centrifuged; 8. Filtrate of 7.

FIG. 3 presents a diagram showing characterisation of gold laden cellulose biomass. A) SEM image of sole cellulose support material. B) SEM image of AuNPs loaded on cellulose. C) SEM-EDS mapping confirming nanoparticles on cellulose are gold and highlighting their purity. D) XPS showing gold on biomass exists in its metallic state (oxidation state of 0).

### DETAILED DESCRIPTION

The invention relates to methods of recovering precious and/or desirable metals from solution, such as solution formed by the dissolution of solid, metal containing feedstock, such as electronic waste, ores, tailings, catalytic converters, and the like. The method comprises the selective reduction of one or more species of target metal ions and binding to a support material, followed by separation of the support material and recovery of the target metal.

A wide range of solid feedstocks, of metal-containing solutions, including solutions having a wide range of concentrations of target and non-target metals, and of support materials are amenable to use in the methods disclosed herein. Examples of commercially relevant representative examples, such as those providing loadings of 2% Au on cellulose support material, are exemplified herein.

Broadly, support material (such as cellulose) is added to a pregnant solution comprising target metal (gold or other precious metal) ions and fully suspended, typically by mechanical agitation. At commercially relevant scale, the pregnant solution will generally have from 1-10 ppm gold to 1000s of ppm target metal and 10s or 100s to 1000s or 10000s or greater ppm of non-target metal. After a period, a reducing agent having a reducing potential effective to reduce at least one species of the target metal ions to target metal but ineffective to reduce at least one species of non-target metal ions present is added, and agitation continues for a further period to allow binding of the reduced target metal to the support material. On the completion of reduction and binding, the precious metal-laden support material is conveniently filtered from the solution, which from the perspective of target metal is now barren. In certain examples, the filtrate is tested to determine the concentration of residual precious metal, and optionally the presence or absence of one or more non-target metals or other contaminants, and the target metal is recovered from the target metal-laden support material, for example by burning. However, as disclosed herein, methods to allow for the recovery of target metal and the reuse of support material are disclosed herein, and will in certain circumstances be advantageously employed.

### SELECTED DEFINITIONS

The term “and/or” can mean “and” or “or”.

Those skilled in the art will appreciate the meaning of various terms of degree used herein. For example, as used herein in the context of referring to an amount (e.g., “about 9%”), the term “about” represents an amount close to and including the stated amount that still performs a desired function or achieves a desired result, e.g. “about 9%” can include 9% and amounts close to 9% that still perform a desired function or achieve a desired result. For example, the term “about” can refer to an amount that is within less than 10% of, within less than 5% of, within less than 1% of, within less than 0.1% of, or within less than 0.01% of the stated amount. It is also intended that where the term “about” is used, for example with reference to a figure, concentration, amount, integer or value, the exact figure, concentration, amount, integer or value is also specifically contemplated.

The term “comprising” as used in this specification means “consisting at least in part of”. When interpreting each statement in this specification that includes the term “comprising”, features other than that or those prefaced by the term may also be present. Related terms such as “comprise” and “comprises”, and the terms “including”, “include” and “includes” are to be interpreted in the same manner.

The term “consisting essentially of” when used in this specification refers to the features stated and allows for the presence of other features that do not materially alter the basic characteristics of the features specified.

The term “consisting of” as used herein means the specified materials or steps of the claimed invention, excluding any element, step, or ingredient not specified in the claim.

The term “contacting” refers to the bringing together, frequently by the mixing of and/or interaction between, two or more entities, such as two or more solutions or substances. One example of this is the contact between a pregnant solution and a support material. A further example of this is the contact between a lixiviant and a solid feedstock material.

The term “target metal” includes both elemental metal and ions of a target metal or a plurality of metals. It is recognised that a particular target metal may exist in different ionic states (including elemental form) or a plurality of ionic states in different steps of the methods or parts of the systems disclosed herein. In specifically contemplated examples, the target metal is dissolved or partially dissolved in the solutions employed herein, either as an ion (or ions), salts or complex or elemental form or a combination thereof. Similarly, the target metal may exist in solid form either as an ion (or ions), salts or complex or elemental form or a combination thereof as the context dictates.

The term “non-target material” refers to materials from the precious metal feedstock (such as, but not limited to electronic waste or automotive catalytic converters) that are not immediately desired for recovery. The non-target material may contain metals and/or non metals that are not target metal(s) and may include epoxy, ceramics, glass fibre, and base metals. It will be appreciated that, in certain examples disclosed herein relating to iterative recovery of target metals, a first iteration of the method (i.e., the addition, maintaining, and recovery steps of the method) in which a first reducing agent is employed will target the recovery of a first target metal or a combination of target metals, during which one or more other metals present will be considered a “non-target metal”, and where a second or subsequent iteration of the method (i.e., a second or subsequent round of addition, maintaining and recovery steps) is performed during which one or more of the metals previously considered a non-target metal becomes the or a target metal. Such examples contemplate the advantageous selectivity of recovery afforded by the methods disclosed herein, due at least in part to the appropriate selection of reducing agent and/or support material.

The term “base metal” refers to metal(s) in similar states of matter as per the term “target metal” above, but are not precious metals. A non-exhaustive list of examples of base metals include copper, tin, nickel, lead, iron and zinc.

The term “pregnant solution” refers to a solution, such as an aqueous solution, containing one or more species of dissolved target metal. In some instances a pregnant solution also contains at least some undissolved target metal(s) and/or non-target metal.

The term “barren solution” refers to a solution, including an aqueous solution, containing a depleted amount of dissolved target metal compared with the pregnant solution. It is recognised that in specifically contemplated examples, one or more target metal(s) is substantially or completely absent from the barren solution.

The terms “reducing agent” and “reductant” and grammatical equivalents thereof refer to an agent or combination of agents capable of reducing a target species, for example, capable of reducing a species of metal ion to elemental metal.

The terms “bind”, “bound”, and “binding” and the like, when used in relation to the methods and systems disclosed herein, refers to the association of target metal with a support material(s), including as the context dictates the use of the support material to bind target metal, or the process of metal associating with and/or binding to the support material(s).

The terms “support” and “support material” refers to a material, typically a biomass-derived material, such as cellulose, to which target metal can be bound. As contemplated herein, when the support material is present in a pregnant solution comprising target metal in its atomic form (e.g., that resulting from the reduction of target metal ions by a reducing agent), the atomic target metal associates with and/or is bound to the support material. Without wishing to be bound by any theory, the applicants understand that the support material facilitates the formation of nano-particles of target metal, such that atomic target metal is associated with the support material from which it is recoverable at commercially-relevant scale. It may be used in the plural sense for a mixture of support materials.

The terms “filterable support” and “filterable support material” refer to a support material which can be recovered from solution by filtering, particularly at commercially-relevant scale. It may be used in the plural sense for a mixture of support materials.

The term “metal laden support material” means a support material that has bound or is associated with one or more target metals.

The term “ppm” refers to parts per million and relates to the concentration of an entity (such as a metal or metal ion, a compound, moiety, support material, or the like) in comparison to another entity—that is, the weight:weight ratio of the respective entities. In specific examples contemplated herein, ppm is used in reference to a target or non-target metal in comparison to a solution in which it occurs.

The term “decanted” or “decant” or the like refers to the removal of the upper portion of solution from a liquid, or a solid/liquid mixture, for example a solid/liquid mixture in which the solid fraction has been allowed to settle.

The term “leachate” refers to an aqueous solution in which one or more metals, such as one or more target metal(s), are dissolved. In certain examples of the methods contemplated herein, a leachate is formed by addition of a lixiviant to a feedstock. In certain examples, a leachate will be a pregnant solution comprising one or more target metals or target metal ions.

The term “ligand” as used herein refers to a moiety, molecule, compound or macromolecule capable of binding to a target. In the context of this disclosure, the term ligand will typically mean a moiety, molecule, compound or macromolecule capable of binding to a target metal, for example to form a target metal complex, such as a target metal complex suitable for binding.

The term “lixiviant” refers to an aqueous solution that is capable of dissolving a target metal(s) into an aqueous form.

The term “e-waste” and “electronic waste” refers to electronic waste or waste electrical and electronic equipment (commonly referred to as WEEE).

The term “PCB” means printed circuit board, a form of electronic waste.

The terms “selectivity”, “selectively”, and grammatical equivalents when used in reference to an agent, such as a lixiviant, a leachate, a reducing agent, or a support material, refers to the ability of the agent to preferentially interact, such as to interact with a specified metal ion or species thereof.

For example, when used in reference to a reducing agent, selectivity or selectively refers to the ability of the reducing agent to favourably reduce the one or more specified metal ion species over one or more other metal ion species present (for example one or more non-target metal ion species in a sample and/or solution). In another example, when used in reference to a support material, selectivity or selectively refers to the ability of the support material to favourably bind the one or more specified metal ion species over one or more other metal ion species present (for example one or more non-target metal ion species in a sample and/or solution).

A “system” comprises pipework and other features that would be typically employed to enable the extraction of metals from a feedstock. By way of example, the “system” may include vessels, conduits, pumps, pressure valves, heat exchangers, filters, instrumentation (pressure sensors, flow sensors, pH sensors) and mixing tees (static mixers).

The term “urban precious metal feedstock” and grammatical equivalents refers to precious metal-rich materials produced and used in urban environments, including feedstocks such as but not limited to electronic waste and automotive catalytic converters.

While the following description focuses on particular examples of the invention, namely the recovery of gold and other precious metals from pregnant solutions or solid feedstock material, it should be appreciated that the invention may be applicable to production of alternative target metals as will be known by persons of ordinary skill in the art to which the invention relates.

As discussed herein, the inventors have devised methods for recovering metals from aqueous solutions containing metal ions and/or solid feedstock materials. In particular, the present invention provides methods for recovering metals from aqueous solutions in a manner that has a number of cost and environmental advantages over existing methods.

In a particular aspect there is provided method of recovering one or more target metals from a solution, wherein the solution comprises dissolved metal ions of at least one target metal and dissolved metal ions of at least one non-target metal, the method comprising:
a) adding to the solution a support material and a reducing agent, wherein the reducing agent has a reducing potential effective to reduce at least one species of target metal ions to target metal but ineffective to reduce at least one species of non-target metal ions; and
b) maintaining the solution for a time and under conditions suitable to precipitate the at least one target metal to the support material to form a target metal-laden support material; and
c) separating the metal-laden support material from the solution by filtration; and
d) recovering the at least one target metal from the target metal-laden support material.

It will be appreciated by those skilled in the art on reading this disclosure that a range of reducing agents are available for reducing one or more species of various target metals. Examples of such reducing agents are exemplified herein in the Examples. Advantageously, the methods disclosed herein employ a reducing agent capable of providing selectivity in terms of the metal or metals it reduces. This, coupled with the use of selected support material, enables the efficient recovery of a desired target metal or metals from solution, typically from a solution comprising at least one other metal species that remains in solution. The method thus enables the efficient recovery of highly pure target metal from complex solutions.

In particular examples, the reducing agent is used to selectively reduce the target metal ions to their elemental and/or colloidal forms while leaving non-target metals dissolved in their ionic form.

In certain examples, the target metal(s) and non-target materials are substantially selectively reduced by the reducing agent in a ratio of greater than 1:1000 (target metal:non-target material), or greater than 1:500, or greater than 1:200, or greater than 1:100, or greater than 1:50, or greater than 1:20, or greater than 1:10, or greater than 1:5, or greater than 1:2, or greater than 1:1.

In other particularly contemplated examples, the reducing agent has a reducing potential effective to reduce at least one species of non-target metal, such as at least one species of non-target metal ions that are more reactive than one or more target metal ion species, and is added in an amount insufficient to reduce all of said at least one species of non-target metal ions. Maintaining the solution for a period leads to the reduction of one or more target metal ions to elemental target metal, which in the presence of the support material binds to said support material.

In particularly contemplated examples, the reducing agent is and is added in an amount sufficient to lead to the reduction of substantially all of at least one species of target metal ions to target metal.

In particularly contemplated examples, the reducing agent is and is added in an amount sufficient to provide, at the maintaining step, a solution in which substantially all of at least one target metal is in elemental form.

In particularly contemplated examples, the reducing agent is and is added in an amount sufficient to provide, at the maintaining step, a solution in which substantially all of at least one target metal is in elemental form, and in which at least some of at least one non-target metal is present as an ion.

For example, the reducing agent is and is added in an amount sufficient to provide, at the maintaining step, a solution in which substantially all of at least one target metal is in elemental form, and in which substantially all non-target metals are present as ion species.

The invention has particular utility in efficiently recovering target metal ions, including in certain examples efficiently recovering substantially all or all of the target metal ions present in a solution, so in some examples the pregnant solution contains more than 1000 ppm, or more than 500 ppm, or more than 200 ppm, or more than 100 ppm, or more than 50 ppm, or more than 20 ppm, or more than 10 ppm, or more than 5 ppm, or more than 1 ppm target metal.

In one example the pregnant solution contains between about 0.1 ppm to 1500 ppm, or between about 0.1 ppm to 1000 ppm, or between about 0.1 ppm to 500 ppm, or between about 0.1 ppm to 200 ppm, or between about 0.1 ppm to 100 ppm, or between about 0.1 ppm to 50 ppm, or between about 0.1 ppm to 20 ppm of the target metal. In one example the pregnant solution contains between about 0.5 ppm to 1500 ppm, or between about 0.5 ppm to 1000 ppm, or between about 0.5 ppm to 500 ppm, or between about 0.5 ppm to 200 ppm, or between about 0.5 ppm to 100 ppm, or between about 0.5 ppm to 50 ppm, or between about 0.5 ppm to 20 ppm of the target metal. In one example the pregnant solution contains between about 1 ppm to 1500 ppm, or between about 1 ppm to 1000 ppm, or between about 1 ppm to 500 ppm, or between about 1 ppm to 200 ppm, or between about 1 ppm to 100 ppm, or between about 1 ppm to 50 ppm, or between about 1 ppm to 20 ppm of the target metal.

Those skilled in the art will recognise that the methods disclosed herein have application to metal-containing solutions prepared via a variety of approaches from a variety of feedstocks. The methods disclosed herein will thus in some examples involve one or more pre-processing steps, such as dissolution of solid feedstock to provide a solution comprising target metal.

In certain examples the method is performed in a vessel or system configured for first dissolving target metal from a solid feedstock, such as electronic waste. In particular examples, electronic waste such as printed circuit boards are added to the vessel, wherein a suitable lixiviant is applied leading to at least partial dissolution of one or more target metal(s) to produce a pregnant solution containing one or more species of target metal ions. Those skilled in the art will appreciate suitable lixiviants and conditions necessary to dissolve at least a portion of the target metal.

In accordance with the methods disclosed herein, in certain examples a leachate is provided by dissolution of target metal ions using a lixiviant solution, thereby yielding a pregnant solution. By way of non-limiting example, in one example when gold is the target metal, the pregnant solution is produced by dissolving the target metal(s) in a lixiviant comprising a thiourea-based solution, or a thiosulphate-based solution, or a thiocyanate-based solution, or a cyanide-based solution, or a halogen-based solution, or an aqua regia-based solution, and examples of suitable conditions can be found in Aylmore, Developments in Mineral Processing 15, pp 501-539 (2005) and references therein.

Lixiviant systems suitable for dissolving one or more target metals act at different rates, pH's, temperatures, and ORPs, and those skilled in the art will appreciate how the conditions may be optimised to ensure the target metal(s) are dissolved efficiently. Examples of suitable lixiviant systems include:

### Water and Chlorine

A lixiviant system of water as the solvent plus chlorine gas can be used to dissolve gold. This system is not selective but will dissolve most metals. (A Straightforward Route to Tetrachloroauric Acid from Gold Metal and Molecular Chlorine for Nanoparticle Synthesis. doi:10.3390/met5031454)

### Water Miscible Solvent, Oxidant and Chloride

According to WO 2016/168933, herein incorporated by reference, a lixiviant system comprising glacial acetic acid as the solvent, an oxidant and a chloride source can be used to dissolve gold selectively. For example, acetic acid, hydrochloric acid and chlorine gas was shown to selectively dissolve gold from printed circuit boards. Similarly, a lixiviant system of glacial acetic acid as the solvent plus hydrochloric acid plus calcium hypochlorite can be used to dissolve gold selectively. Additionally, a lixiviant system of glacial acetic acid as the solvent plus hydrogen peroxide plus hydrochloric acid plus calcium chloride can be used to dissolve gold selectively.

### Potassium Iodide and Iodine

A lixiviant system of water as the solvent plus iodine plus potassium iodide can be used to dissolve gold in accordance with U.S. Pat. No. 3,957,505.

### Thiourea

A lixiviant system of thiourea plus ferric ions in a water solvent with a pH between 1-3 can be used to dissolve gold. (Alternative Lixiviants to Cyanide for Leaching Gold Ores, DOI: 10.1016/S0167-4528(05)15021-2)

### Thiosulfate

A lixiviant system of thiosulfate plus ammonia plus copper (II) can be used to dissolve gold. (Alternative Lixiviants to Cyanide for Leaching Gold Ores, DOI: 10.1016/50167-4528(05)15021-2)

### Aqua Regia

A lixiviant system of nitric acid plus hydrochloric acid volume ratio of approximately 1:4 can be used to dissolve gold. (Cyanide and Other Lixiviant Leaching Systems for Gold with Some Practical Applications, DOI: 10.1080/08827509508914125)

### Cyanide

A lixiviant system of sodium cyanide (0.02-0.1%) in a water solvent with a pH between 10-11 that is saturated with air can be used to dissolve gold. (Cyanide and Other Lixiviant Leaching Systems for Gold with Some Practical Applications, DOI: 10.1080/08827509508914125).

In particular examples, the lixiviant system may be used to selectively dissolve target metal while leaving non-target metal and/or non-target material substantially undissolved or dissolved to a smaller degree. Those skilled in the art will recognise that most target metals such as gold are typically less soluble in most lixiviant systems than non-target materials such as base metals. However, in particular examples, at least a portion of the precious target metal is dissolved in the lixiviant system while non target materials are dissolved at a slower rate or to a lesser degree. For example, at least a portion of the precious target metal is dissolved in the lixiviant system while a smaller proportion of the non target metal is dissolved compared to undissolved metal.

In particular examples, the target metal(s) and non-target metals are substantially selectively dissolved by the lixiviant in a ratio of greater than 1:1000 (target metal:non-target metal), or greater than 1:500, or greater than 1:200, or greater than 1:100, or greater than 1:50, or greater than 1:20, or greater than 1:10, or greater than 1:5, or greater than 1:2, or greater than 1:1.

According to WO2016/108933, systems that use acetic acid show greater selectivity towards gold than systems that use other solvents such as water. One such system is the glacial acetic acid, hydrochloric acid and calcium hypochlorite system. This lixiviant showed a molar ratio of 1 part gold to 1.32 parts copper and 0.87 parts nickel at 4 minutes where all the gold is dissolved, starting with an input of 1 part gold to 133.6 parts copper and 38 parts nickel. Another system is glacial acetic acid plus hydrochloric acid plus chlorine, this system showed a molar ratio of 1 part gold to 2.4 parts copper and 0.6 parts nickel at 1 minute where all the gold is dissolved starting with an input of 1 part gold to 138.7 parts copper and 46.6 parts nickel.

In particular examples, the feedstock material/lixiviant mixture may need to be gently heated to over 30 °C, or over 40 °C or over 50 °C to assist with dissolution of the target metals. Similarly, the mixture may be agitated, sonicated, vibrated or otherwise treated to assist with dissolution.

In one configuration of a system contemplated herein, following optional pre-processing such as dissolution of at least a portion of the target metal(s) in a lixiviant, the pregnant solution is contacted in a vessel with one or more support materials and one or more reducing agents. Upon contact, at least a portion of the target metal ions are reduced and bound to the support material such that the support materials become metal laden and the pregnant solution becomes barren. In accordance with certain examples, the support material is contacted with the pregnant solution for at least 2 minutes, or at least 5 minutes, or at least 10 minutes, or at least 30 minutes, or at least 60 minutes, or at least 120 minutes, or for a period of time necessary to bind at least 50% of the precious target metal(s), or at least 60% of the precious target metal(s), or at least 70% of the precious target metal(s), or at least 80% of the precious target metal(s), or at least 90% of the precious target metal(s), or at least 95% of the target metal(s). The time period is in certain examples between about 0.5 and 48 hours, or between about 0.5 and 24 hours, or between about 0.5 and 12 hours, or between about 0.5 and 4 hours, or between about 1 and 3 hours.

In a particularly contemplated example, the support material preferentially binds the target metal over a further metal or metals (such as a non-target metal) in the pregnant solution. The further metal(s) is then separated from the target metal in the separation step while the further metal remains in the barren solution. Example 9 herein shows the preferential nature of the reduction and binding step. The factor of preferential reduction, binding, and recovery will in part depend on the ratio of the metals in the pregnant solution, for example if they are already in similar quantities the mass ratio may not change as much as if there is a large excess of the further metal. However, preferably the support material preferentially binds the target metal over the further metal in the binding step such that the mass ratio of target metal to further metal in the pregnant solution compared to the ratio of the target metal of the further metal bound to the support material increases by a factor of at least 2, or at least 3, or at least 5, or at least 8, or at least 10, or at least 20, or at least 50, or at least 100, or at least 200. The upper limit of the increase in ratio will in part be dependent on the starting ratio, but may be 1,000 or higher. In one example the target metal is gold. In one example the further metal is selected from one or more of copper and nickel.

The conditions necessary to bind the target metal(s) will depend on a number of factors including the reducing agent, pH, the support material, and the concentration of the various components. However, in accordance with a particular example disclosed herein, the support material is added to the pregnant solution at acidic pH. Support materials suitable for use in the methods discussed herein are frequently prepared for use in industrial processes, for example by washing in a buffer solution, for example phosphate, Tris, saline, acetate and/or perchlorate, or in an acid wash, prior to use. While such washing can be utilised in conjunction with the methods contemplated herein, it is not generally required.

A number of support materials, including filterable support materials, are capable of binding target metal once reduced to its atomic form. In certain examples, the support material, such as the filterable support material is advantageously selected from the group consisting of cellulose, modified cellulose, and cellulosic materials. In certain examples, the support material comprises, consists essentially of, or consists of cellulose. In certain examples, the support material comprises, consists essentially of, or consists of a lignocellulosic material, such as a lignocellulosic material selected from the group consisting of wood, wood chips, sawdust, wood pulp, and paper.

In various examples, the support material comprises, consists essentially of, or consists of non-cellular biomass. For example, the support material comprises, consists essentially of, or consists of non-microbial biomass. Selected examples include but are not limited to cellulose, starch, chitosan, chitin, and lecithin.

In one example, the support material does not comprise microbes or microbial material. In one example, the support material does not comprise viable microorganisms, such as viable bacteria.

In particular examples wherein the target metal(s) ion is gold, filterable support materials such as cellulose or modified cellulose are used.

In certain examples, the pregnant solution contains relatively high amounts of target metal, for example greater than 1000 ppm. It is therefore surprising the support material still has the capacity to bind high levels of target metal, and in various examples do so in relatively short time periods, for example in 3 hours or less, even where the target metal is at lower or higher concentrations.

Upon at least partial binding of the target metal, the solution becomes a barren solution, wherein the barren solution contains less of the target metal than the pregnant solution. In particular examples, the barren solution contains less than 0.1 ppm or less than 1 ppm, or less than 2 ppm, or less than 5 ppm, or less than 10 ppm, or less than 20 ppm, or less than 50 ppm, or less than 100 ppm of the target metal. In one example the barren solution contains between about 0.001 and 100 ppm, or between about 0.001 and 50 ppm, or between about 0.001 and 50 ppm, or between about 0.01 and 50 ppm of the target metal(s). In particular examples, the pregnant solution contains at least 10 times more target metal(s) than the barren solution. In one example the pregnant solution contains at least 20 times, or at least 40 times, or at least 45 times, or at least 50 times more target metal(s) than the barren solution.

Those skilled in the art will, on reading this disclosure, appreciate that a number of scalable techniques for separating solids, such as the metal laden support material, from liquids, exist and are suitable for use in the methods disclosed herein. In particularly contemplated examples, separation of the metal-laden support material from the solution is conveniently performed in a separation step that comprises filtration.

It is anticipated that the initial part of the separation step will in certain examples occur in the same vessel as the binding step, wherein the metal laden support material is simply allowed to concentrate via gravity separation. In other examples, the metal laden support material and barren solution are filtered directly, or are passed to a separation module. Examples of processes and/or equipment to separate a support material from a barren solution, and thus being suitable to comprise a separation module in the systems disclosed herein, will be familiar to those skilled in the art. However, by way of example, the metal laden support material may be separated by gravity separation, centrifugation, filtration or a combination thereof such that in each case the barren solution is at least partially removed from the metal laden support material.

Reference to substantially separating should be taken to mean physically separating at least a portion of the barren solution from the metal laden support material. Physically separating refers to having them in separate non-touching locations, for example separate containers rather than touching layers within the same container.

In specifically contemplated examples, the metal laden support material is separated from the barren solution by filtration. Those familiar with the art will recognise the appropriate conditions and equipment necessary for separating the barren solution from the metal laden support material, which following separation can be recovered, for example by being passed to a recovery module in a system contemplated herein.

In certain examples, the separating step comprises separating the metal laden support material by filtration, wherein during the filtration at least 50% of the barren solution is removed from the metal laden support material. In one example at least 60%, or at least 70%, or at least of 80%, or at least 90%, or at least 95% of the barren solution is removed during filtration.

As an example, solutions containing the metal laden support material may be filtered under vacuum through filters with pore size of approximately 1-10 μm or larger to separate the support material from the barren solution. As another example, a cross flow filtration device or membrane bioreactor device may be used to remove the barren solution.

In various examples, the metal laden support material gravity separates from the barren solution over a time period, for example prior to filtration. Following gravity separation, at least a portion of the barren solution can be filtered, decanted, syphoned or otherwise removed leaving the concentrated metal laden support material from which the target metal is then recovered.

In certain examples, the separating step comprises gravity separation of the metal laden support material from the barren solution, wherein at least 50% of the barren solution is removed. In one example at least 60%, or at least 70%, or at least of 80%, or at least 90%, or at least 95% of the barren solution is removed. By way of example, a solution of the support material may be left to sediment by gravity for up to 2 hours, or up to 6 hours, or up to 12 hours, or up to 24 hours, or up to 48 hours, or up to 72 hours before removing the barren solution.

In an alternative example, the metal laden support material can be separated from the barren solution by centrifugation and removal the barren solution. Those familiar with the art will recognise the appropriate conditions and equipment necessary for separating the barren solution from the metal laden support material, which following separation can be recovered, for example by being passed to a recovery module in a system contemplated herein.

In certain examples, the separating step comprises separating the metal laden support material by centrifugation, wherein during the centrifugation at least 50% of the barren aqueous solution is removed from the metal laden support material. In one example at least 60%, or at least 70%, or at least of 80%, or at least 90%, or at least 95% of the barren solution is removed during centrifugation.

Those skilled in the art will recognise operation of a centrifuge will be dependent on the volumes of liquid addressed and the rate of separation required. There are also a number of centrifuge systems that may be employed with the methods and systems disclosed herein including suitable continuous flow centrifugation or decanter centrifuge device.

The separating step is important for a number of reasons. The separating step removes the metal laden support material, and therefore the target metal, from the other components originally present in the pregnant solution (and thus usually still present in the barren solution). The other components can be toxic or corrosive, such as cyanide or acids. The separation step also allows for concentration of the target metal. Following the separation step, the metal laden support material will in certain examples comprise greater than 100 ppm, greater than 200 ppm, greater than 500 ppm, greater than 1000 ppm, greater than 2000 ppm, greater than 3000 ppm, or more of the target metal.

In certain examples, the metal laden support material comprises greater than greater than 4000 ppm, greater than 5000 ppm, greater than 6000 ppm, greater than 7000 ppm, greater than 8000 ppm, greater than 9000 ppm, greater than 10000 ppm, greater than 15000 ppm, greater than 20000 ppm, greater than 25000 ppm, or greater than 30000 ppm of the target metal(s).

In still further examples, the support material comprises about 3.5% (w/w) target metal, about 4% (w/w), about 4.5% (w/w), about 5% (w/w), about 5.5% (w/w), about 6% (w/w), about 6.5% (w/w), about 7% (w/w), about 7.5% (w/w), about 8% (w/w), about 8.5% (w/w), about 9% (w/w), about 9.5% (w/w), about 10% (w/w), about 11% (w/w), about 12% (w/w), about 13% (w/w), about 14% (w/w), about 15% (w/w), or more than 15% (w/w), target metal.

In various examples, the support material comprises less than about 100 ppm non-target metal. For example, the support material comprises less than about 90 ppm non-target metal, less than about 80 ppm, less than about 70 ppm, less than about 60 ppm, less than about 50 ppm, less than about 40 ppm, less than about 30 ppm, less than about 20 ppm, less than about 10 ppm, less than about 5 ppm, less than about 2 ppm, about 1 ppm, or less than about 1 ppm non-target metal.

In various examples, the mass ratio of target metal to non-target metal present on and/or bound to the support material is at least about 100, at least about 500, at least about 1,000, or higher.

Further the inventors have shown significant concentration factors of the target metal from the pregnant solution to the separated support material. The concentration factor of the target metal from the pregnant solution to the support material (i.e., the number of times more concentrated the target metal is in the support material compared to solution) is greater than 5, greater than about 10, greater than about 20, greater than about 50, greater than about 100, greater than about 200, greater than about 300, greater than about 400, greater than about 500, greater than about 600, greater than about 700, greater than about 800, greater than about 900, or greater than about 1000. In various examples the concentration factor of the target metal from the pregnant solution to the support material is greater than about 1500, greater than about 2000, greater than about 3000, greater than about 4000, greater than about 5000, greater than about 6000, greater than about 7000, greater than about 8000, greater than about 9000, greater than about 10000, greater than about 15000, greater than about 20000, greater than about 25000, or greater than about 30000.

This concentration is important as, for example, although lixiviants are widely used in hydrometallurgy to extract metal, the metal must still be recovered from the solution.

The reduction, binding, and separation steps allows for selective separation and/or concentration of metals. For example, Example 9 herein demonstrates preferential recovery of gold from a solution comprising a number of other metals, including zinc, nickel and copper. The reduced gold binds to the support material, so that in the separating step the gold-laden support material is separated from the other metals including copper still present in the barren solution.

Those familiar with the art will on reading this disclosure recognise suitable recovery processes and/or equipment for recovering target metal(s) from the metal laden support material.

However, by way of non-limiting example, the metal may be released from the metal laden support material by resuspension in, or washing with, a solution suitable for target metal dissolution. For example in certain examples, the metal may be released from the metal laden support material by any conditions suitable for dissolving the target metal from other feedstocks, in addition to pH adjustment, such as pH adjustment to a pH less than 3, or pH adjustment to a pH greater than 10. In certain examples the target metal can be resuspended in its colloidal form by complete dissolution of the support material.

In an alternative example, the metal laden support material may be contacted with a liquid containing a compound to elicit release of the target metal(s) into the liquid. By way of example, aqueous cysteine may be used in certain examples to elicit the release of the target metal(s). In certain examples wherein the target metal(s) is gold, approximately 0.3 mM, or approximately 1 mM, or approximately 10 mM, or approximately 30 mM, or approximately 60 mM cysteine solutions may be contacted with the metal laden support material (Kenney et al, Geochimica et Cosmochimica Acta 82, pp 51-60 (2012)). In a related example, aqueous thiosulphate, thiourea, thiocyanate, cyanide or other thiol ligands may be used to elicit release of gold from the support material. Additionally or alternatively, other conditions such as a change in oxidation-reduction potential or temperature may be used to promote release of the target metal(s).

The concentrated solutions may then be subjected to separation and purification procedures such as precipitation of impurities, solvent extraction, binding and ion-exchange to isolate and/or further concentrate the target metal(s). Subsequently, the solutions can be treated by electrorefining process, chemical reduction, or crystallization for target metal(s) recovery or other methods that those skilled in the art will be aware of.

Release of the target metal will in certain examples be done in a smaller volume than the initial leachate, thus concentrating the solution and making it more amenable to conventional refining techniques such as those familiar to persons skilled in the art.

In an alternative example, the separated metal laden support material is dried and burnt and/or smelted to recover the target metal(s), which may be separated from the ash using conventional pyrometallurgy or hydrometallurgy techniques known to those skilled in the art (Hennebel et al., New Biotechnology 32, pp 121-127 (2015)). In certain particularly contemplated examples, the support material (such as cellulose) produces very little ash itself, meaning the predominant component of the burnt metal laden support material is the target metal. The state of the target metal after pyrometallurgical treatment will depend on the metal, for example, noble metals such as gold will typically be in metallic form, while other target metals such as Pd, Pt, Rh will typically be recovered as an oxide or as a mixture of metallic and oxide forms.

It will be apparent that the recovery step can recover the target metal in metallic or ion form. Reference to recovering the target metal should therefore be taken to include recovery of metallic metal or metal ions.

In particular examples of the methods and systems disclosed herein, the target metal is gold. In such examples, the separated gold laden support material may be dried at ambient temperature or 30 °C or 50 °C to minimise water content and then incinerated, for example by muffle furnace or gas torch gently so as to minimise the loss of ash generated. This ash may then be treated with nitric acid to solubilise base metals, filtered, and the gold-containing residue treated with aqua regia (1 part nitric acid to 3 parts hydrochloric acid) to generate a solution of chloroauric acid. In a related example, the gold laden support materials may directly undergo the aforementioned acid treatment without requiring prior incineration. Gold may be precipitated and smelted from chloroauric acid using methods known to those with ordinary knowledge of the art.

In particular examples of the methods and systems disclosed herein, the target metal is gold. In such examples, the separated gold laden support materials may be dried at ambient temperature or 30 °C or 50 °C to minimise water content and then incinerated by gas torch gently so as to minimise the loss of ash generated or by furnace at above 400 °C, or above 500 °C, or above 600 °C, or above 1000 °C. Borax flux may be used to help bind the gold and minimise any loss, the flux also cleans away any oxide impurities from the gold. This ash may then be treated with nitric acid to solubilise base metals, filtered, and the gold-containing residue treated with aqua regia (1 part nitric acid to 3 parts hydrochloric acid) to generate a concentrated solution of chloroauric acid. In a related example, the gold laden support material may directly undergo the aforementioned acid treatment without requiring prior incineration. Gold may be precipitated and smelted from chloroauric acid using methods known to those with ordinary knowledge of the art.

Those skilled in the art will appreciate there may be benefit in treating the feedstock, such as electronic waste, prior to dissolving the target metal(s) with a lixiviant. It is well known that certain feedstocks, particularly electronic waste, contain a wide variety of non-target materials including elements and compounds. Some or all of those non-target materials may have a deleterious effect on the recovery of the target metal(s). In many examples there will be significant benefit to pre-processing the feedstock, such as the electronic waste, prior to dissolving the target metal(s) in the lixiviant to remove certain non-target materials such as certain components, elements, metals and/or compounds.

As such, according to another aspect, there is provided a method of recovering one or more target metal(s) from a solid feedstock such as electronic waste, the method comprising:
(a) an optional pre-processing step comprising removing at least a portion of non-target material(s) from the feedstock, such as the electronic waste;
(b) a dissolution step comprising dissolving target metal from the feedstock with a lixiviant to form a pregnant solution containing the target metal, wherein the solution comprises at least one species of non-target metal;
(c) optionally, a ligand exchange step, converting the dissolved target metal complex in the pregnant solution to a target metal complex that is more suitable for one or more of the subsequent steps;
(d) adding to the solution a support material and a reducing agent, wherein the reducing agent has a reducing potential effective to reduce at least one species of target metal ions to target metal but ineffective to reduce at least one species of non-target metal ions; and
(e) maintaining the solution for a time and under conditions suitable to precipitate the at least one target metal to the support material to form a target metal-laden support material; and (f) separating the metal-laden support material from the solution by filtration; and
(g) recovering the at least one target metal from the target metal-laden support material.

In various examples the method includes a pre-processing step which may comprise one or more operations selected from the group consisting of: chip removal; grinding, for example grinding to a preselected minimum or maximum size; removal of certain density fractions; removal of one or more magnetic materials; and a base metal leach.

For certain feedstocks, such as electronic waste, there are a number of benefits to performing one of more of these pre-processing steps prior to precious metal recovery, including reducing the volume of the material to be processed in the target metal recovery step, removal of certain fractions that may interfere with precious metal recovery or reduce the efficiency of the reduction or binding steps, and enabling selective recovery of certain valuable fractions.

In particular examples the pre-processing step removes at least 50% of the non target material, such as the non-target or base metal(s), prior to the precious metal recovery, or at least 60%, or at least 70%, or at least 80%, or at least 90%, or at least 95% of the non target materials. In particular preferred examples, the pre-processing step removes less than 20%, or less than 10%, or less than 5%, or less than 2%, or less than 1% of the target metal(s).

For example, in one example, there is provided a pre-processing step including multiple operations including chip removal, grinding to a specified particle size, followed by a base metal leach prior to introduction to the dissolution vessel. Systems suitable for carrying out such pre-processing steps in conjunction with the remainder of the method steps are also contemplated herein.

### Chip Removal

In certain examples relating to e-waste, the method includes one or more steps configured to remove chips and other surface mounted components from printed circuit boards prior to precious metal recovery. Those skilled in the art will recognise that chips and other components are typically fixed to printed circuit boards with solder. Soldering on printed circuit boards typically comprises tin and lead, tin and silver or a combination thereof. As such, a chip removal process typically comprises the removal of solder through elevating the temperature of the solder above the melting point of the solder or by dissolving the solder in a suitable solvent. Chips and other components can then be simply removed by shaking, vibrating, scraping or knocking the PCBs such that the chips and other components fall off.

Those skilled in the art will appreciate suitable processes and/or equipment for heating and removing chips and other components from printed circuit boards. However, by way of non-limiting example, the chips and other components may be heated in a trommel device configured for tumbling a plurality of printed circuit boards at elevated temperatures. For example Wang et al (Waste Management, Vol 53, July 2016, 218-224) provide an automated system for dissembling PCBs with heated air at 265 °C can remove solder in 8 mins.

Additionally or alternatively, the chips and other surface mounted components may be removed or recovered by immersing the printed circuit boards in a solvent system suitable for selectively dissolving the solder. Those skilled in the art will recognise there are a number of solvent systems suitable for selectively dissolving solder. For example Yang Jian-guang et al (Journal of Hazardous Material, Vol 304, March 2016, 409-416) provide a 1:1 mixture of SnCl4 and HCl which can remove up to 99% of Tin at 60-90 °C. Additionally or alternatively, Manis Kuma Jha et al (Hydrometallurgy, Vol 121-124, June 2012, 28-34) provide a nitric acid solution for dissolution of Lead and Tin solder comprising 0.2M HNO₃ with solid:liquid ratio of 1 g/100 ml at 90 °C recovers 99.99% of lead in 120 minutes.

During a chip removal process it may be beneficial to recover solder, solder components, chips and other surface mounted components once removed from the printed circuit boards. Those skilled in the art will appreciate there are a number of methods for recovering such materials, for example chips and other surface mounted components may be recovered in a tray and sorted through size exclusion screens.

### Grinding

The dissolution of solid feedstocks will typically be greatly facilitated by reducing the size of the feedstock units, for example by grinding tailings to reduce average particle size. In another example, due to the heterogeneous nature of electronic waste, particularly PCBs, it will usually be desirable to grind the PCB material to a particular size prior to precious metal recovery. In addition, it is recognised that significant quantities of precious metals are embedded within chips or other components and can only be accessed if the PCB material is first ground to a particular size fraction.

Those skilled in the art will appreciate that grinding any material typically results in a distribution of sizes and the resulting distributed sizes may be separated through well known size exclusion or size separating technologies such as size exclusion screens. Those skilled in the art will recognise PCBs can be ground to a particular size though various well know crushers or grinders, such as hammer mills, ball mills, ring rings and shredders or a combination of two or more such mills. By way of example, the grinding step might include a cutting stage followed by a two-step grinding and crushing stage. In the first stage to reduce the size to an average 3 mm, followed by sieving of particles and fed into a second stage to reduce the average size below 1 mm, ideally in the range of 0.1-0.9 mm. Large particles are sieved and returned to the earlier grinding stage for further clarifying (Silvas et al. Waste Management, Vol 46, December 2015, 503-510).

By way of example, grinding to a particle size of less than 1 mm improves the rate of copper and other base metal extractions, however below 0.5 mm no significant improvements are observed. When grinding to particle sizes below 0.075 mm the copper and lead extraction rates are adversely affected (Chen et al. Journal of Cleaner Production, Vol 95, May 2015, 142-147). Since shredding, grinding and milling are energy intensive processes, there is a desire to maximise extraction efficiency while minimising energy consumption.

In particular examples, the pre-processing step includes grinding the printed circuit boards to less than 3 cm, or less than 1 cm, or less than 5000 microns, or less than 2000 microns, or less than 1000 microns, or less than 500 microns, or less than 200 microns, or less than 100 microns, or less than 50 microns, or less than 20 microns. In a preferred example, the pre-processing step includes grinding the PCBs to an average size of 100-900 microns.

### Density Fraction Removal

By way of non-limiting example, particles from a given feedstock containing significant amounts of metal will usually have a higher density than particles that are substantially free of metals. In examples relating to e-waste, once the printed circuit board material has been ground to a smaller particle size, the particles within the ground material will usually differ in weight and density. As such it may be beneficial to separate particles that are substantially free of metals from particles comprising metals. Those skilled in the art will recognise there are a number of well know technologies for separating out ground materials based on density. However, by way of non-limiting example, such particles may be separated using floatation, shaker tables and/or electrostatic separation.

In a particular example relating to e-waste, wherein the printed circuit boards are ground to <200 microns, the method includes removal of substantially metal free particles by electrostatic separation. For example according to Kaya (Waste Management, Vol 57, November 2016, 64-90) are three types of electrostatic separation:
1—Corona electrostatic separation (most useful in producing a metallic and non-metallic mixture with little to no cross-contamination, works best with a 0.6-1.2 mm PCB size for industrial applications);
2—Eddy current separation (useful for recovering Al);
3—triboelectric separation.

Any one or more of such methods are amenable to use in the pre-processing step(s) contemplated herein.

### Removal of Magnetic Material

Precious metals and many base metals are non-magnetic so it may be beneficial to separate magnetic material prior to further treatment. For example, in the context of e-waste, once a printed circuit board material has been ground to a smaller particle size, it may be beneficial to separate magnetic material from non-magnetic material. Magnetic material may be removed using a magnetic field to physically remove magnetic material from non-magnetic materials such as ground printed circuit board substrate. For example, metal and non-metal components are completely dissociated from one another with a crush size below 0.6 mm (Guo Chao Wang Hui et al. Waste Management Vol 31, September-October 2011, 2161-2166). The authors disclose a two step crushing process, which uses sieve sizes (anything above 1.25 mm is recycled into the feed loop), followed by electrostatic separation and magnetic separation.

### Base Metal Leach

Since feedstocks contemplated for use herein, such as printed circuit boards and other e-waste, typically comprise a plurality of different metals and alloys, it will in certain examples be beneficial to separate out some metals prior to precious metal recovery. Those skilled in the art will recognise that most metals have solubility properties based on their electronic configuration, placement on the periodic table, size, hardness/softness as well as other factors. As such, it is possible to substantially dissolve certain metals while leaving others substantially undissolved based on their solubility properties. For example, base metals such as copper, zinc, aluminium, iron, and tin tend to be at least partially soluble in sulfuric acid while precious metals such as gold, palladium, platinum and silver are substantially less soluble. As such, selective dissolution may be used to separate some metals from the feedstock, such as a printed circuit board material.

By way of non-limiting example, certain base metals may be selectively dissolved and separated from precious metal bearing printed circuit board material using techniques including but not limited to:
Kell process (oxidative pyrolysis)
Sulphuric acid leach
Hydrochloric acid leach
Nitric acid leach
Ammonia leach

The Kell process comprises a hydrometallurgical alternative to smelting of concentrates containing base metals and precious metals. The process involves three main steps (commonly on mining ores):
1—Aqueous pressure oxidation in an acidic sulphate medium to dissolve the base metals.
2—Roasting of the previous materials to improve leaching conditions in the final stage.
3—Leaching of precious metals in chloride media to dissolve the remaining metal contents.

The key feature of this process is the separation of the base metal and precious metal chemistries (www.saimm.co.za/Conferences/Pt2010/181-186 Liddell.pdf)

A sulphuric acid leach comprising 2M sulphuric acid and 35% hydrogen peroxide in a 4:1 ratio can be used in a two-step process to selectively dissolve the base metals, including copper, iron, nickel, tin, zinc and aluminium as the most common metals. A solid to liquid ratio of 1:10 was found to be most optimal (Behnamfard et al. Waste Management, 33 (2013) 2345-2363). Furthermore, Kaya (Waste Management, Vol 57 (2016) 64-90) incorporated herein by reference, provides a detailed table of base metal lixiviants: mainly sulphuric and oxidant, also a 6M HNO3 system.

It is also reported that 1-6M nitric acid can be used for the dissolution of base metal, particularly copper, lead and tin (plus other common base metals in shredded e-waste). When concentrations of nitric acid of over 4M are used, tin precipitates as metastannic oxide. Mecucci et al (Journal of Chemical Technology and Biotechnology, Vol 77 (2002) 449-457 claim that nitric acid has advantages over sulphuric acid as it forms less precipitates. Furthermore, nitric acid itself is oxidising so requires less or no extra oxidant and has the potential to be regenerated and/or recycled ore easily.

Fazhul et al (dspace.unimap.edu.my/dspace/bitstream/123456789/7476/1/Selective %20leaching%20for%20the%20recovery%20of%20Copper.pdf) provide a lixiviant comprising ammonia that selectively leaches certain base metals (particularly copper) in the presence of other common base metals. Additionally or alternatively Sun et al. (Environmental Science and Technology Letters, 49 (2015) 7981-7988) provide a process comprising ammonium (7.55 wt %) with 196 g/L ammonia carbonate with air at room temperature and a solid to liquid ratio of 1 g/5 ml can be used to leach to copper, while removing low amounts of other base metals, predominantly zinc (<5% total).

### Recycling Solutions

The inventors recognise the efficiency of the process may be improved by recycling certain solutions and/or the support material used in the methods disclosed herein. For example, certain examples comprise the recycling of at least a portion of the barren solution separated from the metal laden support materials back into the dissolution step. In other examples, the metal-laden support material is recovered and reused, for example as exemplified herein in Example 6.

It is anticipated that in certain examples, a recycling step reduces the amount of one or more reagents, such as water, needed by the overall system thus making it increasingly cost and/or environmentally efficient. In certain examples, the efficiency of the process is facilitated by increasing the amount of target metal bound to the support material, by iteratively binding target metal to reused support material thereby increasing the concentration of target metal with respect to support material.

In examples where the barren solution is reused, it is appreciated that the barren solution may contain metal ions and in some instances may even include some residual target metal ions. In some examples the barren solution is treated to remove excess metal ions or other compounds prior to recycling. In some examples, at least a portion of the barren solution is mixed with makeup water or other suitable liquid prior to recycling.

It is further recognised that additional components may need to be added to the barren solution such that it can act as a lixiviant. For example, in certain examples where the lixiviant is thiosulfate or cyanide or thiourea or chlorine, the active lixiviant agent(s) may need to be at least partially recharged to enable further dissolution of the target metal(s). In certain examples, these additional components are added to the barren solution prior to recycling. Additionally or alternatively, the barren solution may need to be treated to adjust the pH, the ORP, the temperature or any other physical properties that might be known to those skilled in the art in order to make it a suitable lixiviant.

In certain examples of the systems contemplated herein for carrying out the methods disclosed, there is provided a passage for returning at least a portion of the barren solution from the or a separation vessel to the dissolution vessel.

In particular examples at least 25% of the barren solution is recycled. In other examples, at least 35%, or at least 45%, or at least 55%, or at least 65%, or at least 75%, or at least 85%, or at least 95% of the barren solutions is recycled.

Unless indicated otherwise, the order of steps described in the methods described herein has been optimised by trials carried out by the inventors to ensure that the process provides an efficient yield and an economically viable recovery method.

The invention is further described with reference to the following examples. It will be appreciated that the invention as claimed is not intended to be limited in any way by these examples.

### EXAMPLES

### Example 1. Stoichiometry

This example presents experiments investigating the amount of support material and reductant to be added for useful recovery of one or more target metals from solution.

### Materials and Methods:

Varying amounts of support material and reducing agent were added to a 20 ppm gold electronic waste leachate. Two different amounts of the support material (see Table 1 below), in this case fine cellulose, were added to samples of the leachate and fully suspended by mechanical agitation. Reducing agent, in this example ascorbic acid, was then added in two different amounts (again, see Table 1 below) to samples of the support material/leachate mixture, and agitation was continued for several minutes to ensure adequate mixing and reduction of the target metal ions to target metal and binding to the support material. A negative control (21-A in Table 1 below), in which no cellulose or ascorbic acid were added, was included.

After the addition of the reductant, the samples were maintained for a suitable time (here, 4 hours), and the target metal-laden support material was then recovered by filtration. The filtrate was tested to determine the concentration of residual target metal, while the amount of gold recovered from the support material was determined by digesting the cellulose support material via aqua regia (AR).

### Results:

As shown in Table 1 below, changing the amount of cellulose from 1.67 mg/ml (21-E) to 5 mg/ml (21-F & 21-G) did not appreciably impact the amount of gold recovered on the support material or that remained present in the filtrate. Similarly, changing the amount of ascorbic acid from 0.17 mg/ml (21-G) to 1 mg/ml (21-E & 21-F) did not appreciably impact gold recovery. The concentration of gold present in the solution of the negative control remained unchanged.

TABLE 1
Effect of relative amounts of support material and reducing agent

| | | Initial | | | Centrifuged | Filtered |
|---|---|---|---|---|---|---|
| So- | Volume | [Au] | Additive | Additive | [Au] | [Au] |
| lution | (mL) | (ppm) | 1 | 2 | (ppm) | (ppm) |
| 21-A | 30 mL | 19.80 | — | — | 19.73 | 18.92 |
| 21-E | 30 mL | 19.80 | CFA150 | Ascorbic | 1.71 | 2.58 |
| | | | 50 mg | acid | | |
| | | | | 30 mg | | |
| 21-F | 30 mL | 19.80 | CFA150 | Ascorbic | 1.58 | 1.70 |
| | | | 150 mg | acid | | |
| | | | | 30 mg | | |
| 21-G | 30 mL | 19.80 | CFA150 | Ascorbic | 2.66 | 3.16 |
| | | | 150 mg | acid | | |
| | | | | 5 mg | | |

These results show that efficient recovery of target metal is possible using the methods described herein across a large range of amounts of each of the support material (here, cellulose) and the reducing agent (here, ascorbic acid).

### Example 2. Addition of Support Material and Reducing Agent

This example presents experiments investigating the order of addition of support material and reducing agent on the recovery of one or more target metals from solution.

### Materials and Methods:

Support material and reducing agent were added to a 20 ppm gold electronic waste leachate. For one sample (21-D in Table 2 below), the reducing agent was added to the leachate first and mixed by mechanical agitation, followed by addition of the support material and further mechanical agitation. The order of addition was reversed for the other sample (21-E in Table 2 below), with support material added first followed by reducing agent. Again, a negative control (21-A in Table 2 below), in which no cellulose or ascorbic acid were added, was included.

As for Example 1 above, samples were maintained for 4 hours following addition of reductant, then the target metal-laden support material was recovered by filtration. The filtrate was tested to determine the concentration of residual target metal, while the amount of gold recovered from the support material was determined by digesting the cellulose support material via anaerobic respiration.

### Results:

As shown in Table 2 below, changing the order of addition of support material and reducing agent did not appreciably impact the amount of gold recovered on the support material or that remained present in the filtrate. The recovery of gold observed for 21-E, in which support material was added first, was comparable to that observed with 21-D, in which reducing agent was added first. Again, the concentration of gold present in the solution of the negative control remained unchanged.

TABLE 2
Effect of relative amounts of support material and reducing agent

| | | Initial | | | Centrifuged | Filtered |
|---|---|---|---|---|---|---|
| So- | | [Au] | Additive | Additive | [Au] | [Au] |
| lution | Volume | (ppm) | 1 | 2 | (ppm) | (ppm) |
| 21-A | 30 mL | 19.80 | — | — | 19.73 | 18.92 |
| 21-D | 30 mL | 19.80 | Ascorbic | CFA150 | 1.54 | 2.74 |
| | | | acid | 50 mg | | |
| | | | 30 mg | | | |
| 21-E | 30 mL | 19.80 | CFA150 | Ascorbic | 1.71 | 2.58 |
| | | | 50 mg | acid | | |
| | | | | 30 mg | | |

These results show that efficient recovery of target metal is possible using the methods described herein irrespective of the order in which the support material (here, cellulose) and the reducing agent (here, ascorbic acid) were added. Accordingly, and without wishing to be bound by any theory, the inventors expect that the methods described herein are amenable to implementation across a range of practical considerations, and can accommodate a range of workflows, plant designs, and the like, without negatively impacting yield and/or efficiency.

### Example 3. Support Material

This example presents experiments exploring the characteristics of the support material and their effect on the recovery of one or more target metals from solution. Cellulose is a desirable support material for efficient recovery of target metal by burning as it has a low ash content. Several grades of cellulose were investigated.

### Materials and Methods:

Fine, medium, and coarse examples of support material were each added to separate samples of 27.1 ppm gold electronic waste leachate together with reducing agent. Here, equivalent amounts of fine cellulose (CFA150, 24-A in Table 3 below), medium cellulose (CFA250, 24-B in Table 3 below), and coarse cellulose (CFA1200, 24-C in Table 3 below), were assessed. Equivalent amounts of ascorbic acid reducing agent was added to each sample as shown in Table 3. All samples were incubated with agitation for 1 hour to allow for reduction and binding of target metal to the support material.

The target metal-laden support material was then recovered by filtration. The filtrate was tested to determine the concentration of residual target metal, while the amount of gold recovered from the support material was determined by digesting the cellulose support material via anaerobic respiration.

### Results:

As shown in Table 3 below, the grade (particle size) of cellulose had no appreciable difference on the yield of gold recovered. However, as shown in Table 3, the time taken to filter the sample comprising coarse cellulose (24-C, CFA1200) was much less than that taken to filter the fine and medium cellulose-containing samples (24-A, CFA150; 24-B, CFA250; respectively).

TABLE 3
Effect of support material

| | | | | Cellulose | Ascorbic | [Au] | Filter | [Au] | |
|---|---|---|---|---|---|---|---|---|---|
| | Volume | [Au] | Cellulose | mass | acid | centrifuge | time | filtrate | Yield_{filtrate} |
| Sample | (mL) | (ppm) | type | (g/m · eq.) | (g/n · eq.) | (ppm) | (sec) | (ppm) | % |
| 24-A | 40 | 27.1 | CFA150 | 0.08/74 | 0.04/144 | 0.75 | 14 | 0.71 | 97.4 |
| 24-B | 40 | 27.1 | CFA250 | 0.08/74 | 0.04/144 | 0.75 | 13 | −0.22 | 100.8 |
| 24-C | 40 | 27.1 | CFA1200 | 0.08/74 | 0.04/144 | 0.52 | 6 | 1.27 | 95.3 |

These results show that efficient recovery of target metal is possible using the methods described herein with support materials of quite varied coarseness. Interestingly, the use of comparatively coarse support material enables the rapid filtration and separation of metal-laden support material without negatively impacting the efficiency of recovery. Those skilled in the art will appreciate that improvements in processing speeds have the potential to have meaningful commercial impact.

### Example 4. Support Material

This example presents experiments exploring the relative amounts of support material required for efficient recovery of one or more target metals from solution.

### Materials and Methods:

Coarse support material (cellulose CFA1200) was added in varying amounts to separate samples of 27.1 ppm gold electronic waste leachate along with reducing agent. Here, five amounts of cellulose CFA1200, ranging from 10 mass equivalents (relative to target metal amount) to 185 mass equivalents (as shown in Table 4 below) were assessed. Equivalent amounts of ascorbic acid reducing agent was added to each sample as shown in Table 4. All samples were incubated with agitation for 1 hour to allow for reduction and binding of target metal to the support material.

As above, the target metal-laden support material was recovered by filtration. The filtrate was tested to determine the concentration of residual target metal, while the amount of gold recovered from the support material was determined by digesting the cellulose support material via anaerobic respiration.

### Results:

As shown in Table 4 below, the amount of support material across the assessed range had not appreciable impact on the efficiency of recovery. Greater than 99% recovery was observed in all samples tested, from 25-B, in which a 1:10 mass equivalent of Au:cellulose was employed, resulting in a yield of 99.2%, through to 25-E, in which a 1:185 mass equivalent of Au:cellulose provided a yield of 99.3%.

TABLE 4
Effect of amount of support material

| | | | | Cellulose | Ascorbic | [Au] | [Au] | |
|---|---|---|---|---|---|---|---|---|
| | Volume | [Au] | Cellulose | mass | acid | centrifuge | filtrate | Yield_{filtrate} |
| Sample | (mL) | (ppm) | type | (g/m · eq.) | (g/n · eq.) | (ppm) | (ppm) | % |
| 25-B | 40 | 27.1 | CFA1200 | 0.01/10 | 0.04/144 | −0.32 | 0.23 | 99.2 |
| 25-C | 40 | 27.1 | CFA1200 | 0.03/28 | 0.04/144 | −0.41 | −0.31 | 101.1 |
| 25-D | 40 | 27.1 | CFA1200 | 0.05/46 | 0.04/144 | −0.37 | 0.20 | 99.3 |
| 24-C | 40 | 27.1 | CFA1200 | 0.08/74 | 0.04/144 | 0.52 | 1.27 | 95.3 |
| 25-E | 40 | 27.1 | CFA1200 | 0.2/185 | 0.04/144 | −0.46 | 0.20 | 99.3 |

Dilutions are all 5x

These data show that a >99% yield can be achieved when using the methods described herein with as little as a 1:10 mass equivalent of target metal:support material.

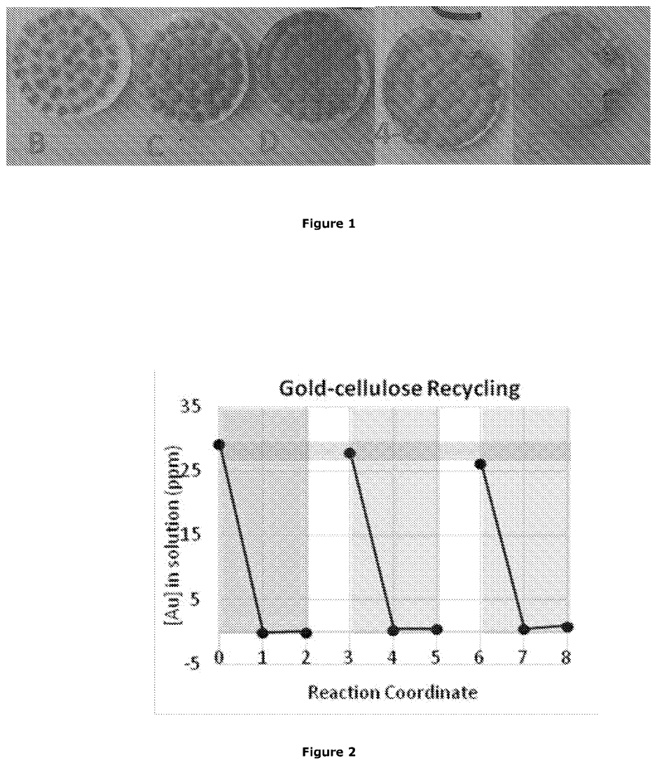

While in certain examples, minimising the amount of support material required to enable efficient recovery will be advantageous, in certain examples (particularly those in which recovery and reuse of the support material is possible) the use of higher mass equivalents of support material can be advantageously employed. As shown in FIG. 1, inspection of the filter pads resulting from each sample showed that, at least for small volumes, a greater amount of support material will enable easier recovery of support material from the filter support, thereby minimising loss of target metal by undesired loss of metal laden support material—compare FIG. 1 B (25-B1) to FIG. 1 E (25-E).

### Example 5. Selectivity of Metal Recovery

This example presents the analysis of the experiments described above to elucidate the selectivity of metal recovery, and particularly the selectivity of target metal over base (non-target) metals present in the test solutions.

### Materials and Methods:

Various samples from the preceding Examples were analysed to determine the concentration of certain base metals commonly seen in electronic waste before and after binding.

### Results:

As shown in Table 5 below, the methods employed in the Examples above were highly selective for the target metal, gold. From a starting concentration of 27.1 ppm, the amount of residual gold present in filtrate after binding was minimal, with a maximum residual concentration observed in sample 24-C1 of 1.27 ppm.

In contrast, as presented in Table 5 essentially all of each non-target metal (Sn, Ni, Fe, Al, Zn, Cu, Mg) was retained in solution after gold metal binding took place.

TABLE 5
Selectivity of target metal over base metals

| | | Au | Sn | Ni | Fe | Al | Zn | Cu | Mg |
|---|---|---|---|---|---|---|---|---|---|
| History | Sample | ppm | ppm | ppm | ppm | ppm | ppm | ppm | ppm |
| PML + prebio | DT2-24-Initial | 27.1 | 8.8 | 20.0 | 1.5 | 166.7 | 10.1 | 70.3 | 397.1 |
| Cellulose/AA | 24-A1 | 0.71 | 9.7 | 20.3 | 1.5 | 166.2 | 9.5 | 71.2 | 392.0 |
| Cellulose/AA | 24-B1 | −0.22 | 9.9 | 21.3 | 1.5 | 176.2 | 12.3 | 74.0 | 411.5 |
| Cellulose/AA | 24-C1 | 1.27 | 10.1 | 21.0 | 1.5 | 172.1 | 9.4 | 72.4 | 409.1 |
| Cellulose/AA | 25-A1 | −0.96 | 8.9 | 21.0 | 1.5 | 174.2 | 13.1 | 71.6 | 403.0 |
| Cellulose/AA | 25-B1 | −0.32 | 8.6 | 21.2 | 1.5 | 178.7 | 11.5 | 73.7 | 410.5 |
| Cellulose/AA | 25-C1 | −0.41 | 8.6 | 21.0 | 1.5 | 176.3 | 11.2 | 72.6 | 405.7 |
| Cellulose/AA | 25-D1 | −0.37 | 9.0 | 21.2 | 1.7 | 195.2 | 10.3 | 73.6 | 409.0 |
| Cellulose/AA | 25-E1 | −0.46 | 8.7 | 22.6 | 1.7 | 198.2 | 11.7 | 74.2 | 419.1 |

These results show that efficient and highly selective recovery of target metal is possible using the methods described herein, even in the presence of complex solutions comprising multiple species of metal ions/multiple non-target metals. Those skilled in the art will appreciate that the methods described and exemplified herein are capable of iterative binding steps, whereby different metals are sequentially targeted for binding/removal from the leachate solution through selection of appropriate reducing agents and/or support materials.

### Example 6. Recovery and Reuse of Support Material

This example presents experiments exploring the effect of reusing the support material on the recovery of one or more target metals from solution.

### Materials and Methods:

Coarse support material (cellulose CFA1200) was added to separate samples of 27.1 ppm gold electronic waste leachate along with ascorbic acid reducing agent. All samples were incubated with agitation for 1 hour to allow for reduction and binding of target metal to the support material.

As above, the target metal-laden support material was recovered by filtration. The filtrate was centrifuged and tested to determine the concentration of residual target metal, while the amount of gold recovered from a sample of the support material was determined. After the first round of binding, the metal laden support material was air dried for several minutes until it was visually dry.

The dried, metal-laden cellulose was then used in a second round of binding. The recovered support material was added to fresh leachate solution comprising 27.1 ppm gold together with fresh ascorbic acid, incubated with agitation, followed by filtration. This procedure was repeated for a third round of binding, again with fresh leachate and reducing agent. The amount of gold recovered was assessed as described in the Examples above.

### Results:

As shown in FIG. 2, substantially complete depletion of gold from the leachate and binding to the reused cellulose support material was achieved in each round of binding. In this case, a gold loading of 1:50 Au:support material was repeated 3 times leading to a theoretical 3:50 Au:cellulose support material loading.

### Example 7. Recovery Conditions

This example presents the analysis of the conditions affecting the binding of target metal to support material and the resulting recovery and yield.

### Materials and Methods:

Electronic waste feedstock was incubated with chlorine based lixiviant (prepared by dissolving trichloroisocyanuric acid (TCCA) in water) to dissolve target and non-target metals. The reaction was quenched by addition of sodium hydroxide after completion at 3 hours to pH=~7 (to minimize Cl₂ gas off) and filtered. Once the e-waste had been filtered, aliquots of the resulting solution were then either acidified (with HCl, see Table 6 below), basified (with NaOH, see Table 6) or left unchanged and a standard dechlorination process was applied (0.5 mL H₂O₂ added in a single portion). After the cyanuric acid (derived from TCCA) was filtered from solution, identical binding experiments (50 mg cellulose (CFA250) support material, 40 mg ascorbic acid) with 30 minutes incubation were performed.

### Results:

The results presented in Table 6 below show that a pH of about 4.5 or less when the reaction is dechlorinated substantially improved target metal yield compared to pH of ~7 or above—compare 35-A & 35-B to DY-35-C & 35-D.

TABLE 6
Effect of reaction conditions (pH) on recovery

| Sample | Vₗᵢₓ (mL) | Additive | pH | V_{H2O2} (mL) | CYAₚₚₜ (g) | [Au]_{Initial} | [Au]_{Final} | Yield |
|---|---|---|---|---|---|---|---|---|
| 35-A | 90 | 1 mL HCl | 1.72 | 0.5 | 1.442 | 15.74 | 0.51 | 97% |
| 35-B | 90 | 0.5 mL HCl | 4.44 | 0.5 | 1.405 | 16.13 | 0.37 | 98% |
| 35-C | 90 | None | 6.97 | 0.5 | 1.277 | 15.12 | 11.03 | 27% |
| 35-D | 90 | 0.5 mL 50% | 10.43 | 0.5 | 1.700 | 8.83 | 6.37 | 25% |
| | | NaOH | | | | | | |

These data suggest that, in order to achieve acceptable binding and useful yield, an acidic pH a40ichlorinationnation step is desirable.

### Example 8. Target Metal Recovery

This example presents the analysis of the conditions affecting the binding of target metals other than gold to the support material and the resulting recovery of such target metals.

### Materials and Methods:

Palladium (Pd) is also present in e-waste, albeit usually at lower concentrations than gold. A concentrated Pd solution was formed using lixiviant created by exposing spent 10% Pd/C catalyst to chlorine in water. The binding conditions described in the Examples above (40 ml solution, 150 mg cellulose (CFA250) support material, 40 mg ascorbic acid) were used.

### Results:

The results presented in Table 7 below show that palladium was able to be recovered with high yield.

TABLE 7
Recovery of target metals other than gold

| Sample | Type | [Pd] | Yield |
|---|---|---|---|
| 30-1 | initial | 74.1275 | |
| 30-4 | final | 2.456 | 97% |

These data show that target metals other than gold, in this case palladium, can be readily recovered from concentrated lixiviant using the methods described herein.

### Example 9. Recovery of Target Metals Using Various Reducing Agents

This example presents the analysis of the use of various reducing agents and their effect on the binding of target and various non-target metals to support material and the resulting selectivity of recovery and on yield.

### Materials and Methods:

The representative reducing agents ascorbic acid, hydrazine sulfate, citric acid (in equimolar amounts) and sodium borohydride were assessed for gold reduction and selectivity with regard to base metals. Samples of each reductant was incubated with complex mixtures of gold and various non-target metals, one for 1 hour and an otherwise equivalent sample overnight.

### Results:

As shown in Table 8 below, sodium borohydride was effective to remove all gold within 1 hour, whereas ascorbic acid removed 90% of the gold present at this time point. In contrast, hydrazine only removed ~40% of the gold within this period, and citric acid removed only a negligible amount. After stirring overnight, ascorbic acid had removed all the gold, as had the stronger reductant sodium borohydride. Despite the overnight incubation, gold recovery with hydrazine remained inefficient, with only marginally more gold removed compared to the shorter duration incubation. Overnight incubation with citric acid was ineffective at removing gold from solution.

Turning to the base (non-target) metals, some degree of removal of each base metal other than sodium was observed after stirring overnight with sodium borohydride. Likewise, some degree of removal of each base metal was observed after overnight stirring with citric acid. Neither ascorbic acid or hydrazine were effective to remove base metals with overnight stirring, showing high selectivity for gold.

TABLE 8
Effect of reductant on recovery of target and non-target metals

| Sample | Reductant | Time | Au | Al | Ca | Co | Cr | Cu | Fe | Mg | Mn | Na | Ni | Pb | Sn | Zn |
|---|---|---|---|---|---|---|---|---|---|---|---|---|---|---|---|---|
| 39-I | — | | 2.1496 | 255 | 1124.83 | — | 16.99 | 44.85 | 60.07 | 521.9 | 0.68 | 163.47 | 19.38 | 7.43 | 1.62 | 10.01 |
| 39-A1 | Ascorbic | 1 h | 12% | 98% | 101% | | 101% | 101% | 100% | 101% | 101% | 105% | 101% | 102% | 107% | 94% |
| 39-A2 | acid | o/n | 0% | 104% | 104% | | 105% | 105% | 104% | 104% | 107% | 111% | 105% | 106% | 110% | 106% |
| 39-B1 | Hydrazine | 1 h | 62% | 99% | 102% | | 101% | 102% | 100% | 101% | 101% | 104% | 101% | 104% | 96% | 96% |
| 39-B2 | sulfate | o/n | 54% | 100% | 102% | | 102% | 103% | 102% | 103% | 103% | 108% | 102% | 104% | 97% | 101% |
| 39-C1 | NaBH4 | 1 h | 0% | 100% | 104% | | 100% | 98% | 97% | 99% | 97% | 208% | 97% | 101% | 112% | 83% |
| 39-C2 | | o/n | 0% | 85% | 87% | | 87% | 83% | 82% | 85% | 81% | 154% | 80% | 82% | 93% | 75% |
| 39-D1 | Citric | 1 h | 99% | 100% | 102% | | 101% | 103% | 102% | 102% | 104% | 106% | 101% | 104% | 101% | 96% |
| 39-D2 | acid | o/n | 96% | 92% | 88% | | 94% | 93% | 94% | 92% | 93% | 84% | 93% | 91% | 87% | 97% |

Without wishing to be bound by any theory, the inventors believe that the base metals removed from solution overnight with sodium borohydride have been reduced, but are not attached to the support material and are as fine particulate flakes. Metals complexed by citric acid are unlikely to have been reduced and instead are electrostatically attached to the cellulose support material. These data show that ascorbic acid and hydrazine both show excellent selectivity for gold over the non-target base metals commonly found in e-waste, with ascorbic acid also showing excellent efficacy in recovering gold.

Any method detailed herein also corresponds to a disclosure of a device and/or system configured to execute one, or more, or all, of the method actions. Likewise, any disclosure of a device and/or system detailed herein corresponds to a method of making and/or using the device and/or system, including a method of using that device according to the functionality detailed herein. And any disclosure of a device and/or system detailed herein also corresponds to a disclosure of otherwise providing that device and/or system.

It should be noted that various changes and modifications to the presently preferred examples described herein will be apparent to those skilled in the art. Such changes and modifications may be made without departing from the spirit and scope of the invention and without diminishing its attendant advantages. It is therefore intended that such changes and modifications be included within the present invention.

The invention has been described herein, with reference to certain preferred examples, in order to enable the reader to practice the invention without undue experimentation. However, a person having ordinary skill in the art will readily recognise that many of the components and parameters may be varied or modified to a certain extent or substituted for known equivalents without departing from the scope of the invention. It should be appreciated that such modifications and equivalents are herein incorporated as if individually set forth.

Titles, headings, or the like are provided to enhance the reader's comprehension of this document, and should not be read as limiting the scope of the present invention.

The entire disclosures of all applications, patents and publications, cited above and below, if any, are hereby incorporated by reference.

The reference to any prior art in this specification is not, and should not be taken as, an acknowledgment or any form of suggestion that that prior art forms part of the common general knowledge in the United States of America or any country in the world.

Throughout this specification and any claims which follow, unless the context requires otherwise, the words “comprise”, “comprising” and the like, are to be construed in an inclusive sense as opposed to an exclusive sense, that is to say, in the sense of “including, but not limited to”.

The invention may also be said broadly to consist in the parts, elements and features referred to or indicated in the specification of the application, individually or collectively, in any or all combinations of two or more of said parts, elements or features.

In at least some exemplary examples, any feature disclosed herein can be utilized in combination with any other feature disclosed herein unless otherwise specified. Accordingly, exemplary examples include a medical device including one or more or all of the teachings detailed herein, in any combination. While various examples have been described, they have been presented by way of example only, and not limitation. Changes in form and/or detail can be made therein without departing from the invention.

### Example 10—Effect of Other Biomass Derived Support Materials

Other non-cellular biomass derived support materials, in addition to cellulose, may be used to recover gold from solution (table 9). A solution containing 20 ppm gold derived from leaching e-waste as described in example 7 was used to test this. In the presented cases, less gold is retained in the solid filtered from solution compared to cellulose—a fact that is wholly due to the solubility of the biological supports in lixiviant media or their particle size. Any soluble component of support material, or component smaller than the filter pore, still binds gold, but it is not in a filterable and therefore recoverable form.

The trend of deposition yields of cellulose>starch>chitin>chitosan>lecithin observed supports this. Cellulose is completely insoluble and has a robust polymer structure, whereas the amylose component of starch can form fine colloidal suspensions capable of passing through a standard sized filter (approx. 10 μm). Although chitin is traditionally insoluble, hydrolysis of the acetyl groups can convert it into chitosan, which is fairly soluble in the acidic lixiviant conditions (pH=1). Finally, lecithin is partially soluble in water and forms emulsions rendering the filterable component very small. In our experiments, lecithin formed a thin gel which could not be filtered under standard conditions used hence the lack of deposition yield.

Without wishing to be bound by any theory, the inventors believe it is therefore important to select a biosorbent that is totally insoluble in the pregnant solution for maximum yields of recovered target metal. Without wishing to be bound by any theory, the inventors believe that certain non-cellular support materials are likely to be more suitable in some applications, for example applications not explicitly detailed in this Example.

TABLE 9
Effect of type of biomass on recovery of target metal

| | | Support | | Reductant | Deposition |
|---|---|---|---|---|---|
| Support | [Au] | mass | Reductant | mass | yield |
| Material | (ppm) | (g/L) | used | (g/L) | (%) |
| Cellulose | 20 | 20 | Ascorbic acid | 1 | 100 |
| Starch | 20 | 20 | Ascorbic acid | 1 | 73 |
| Chitin | 20 | 20 | Ascorbic acid | 1 | 32 |
| Chitosan | 20 | 20 | Ascorbic acid | 1 | 17 |
| Lecithin | 20 | 20 | Ascorbic acid | 1 | 0 |

### Example 11—Characterisation of Gold on Biomass

In the cases presented here, the target metal gold is reduced by the reductant to a nanoparticle form on the biomass. To prove this, gold laden biomass was analysed by SEM (scanning electron microscopy), SEM-EDS (electron dispersive spectroscopy), and XPS (X-ray photoelectron spectroscopy).

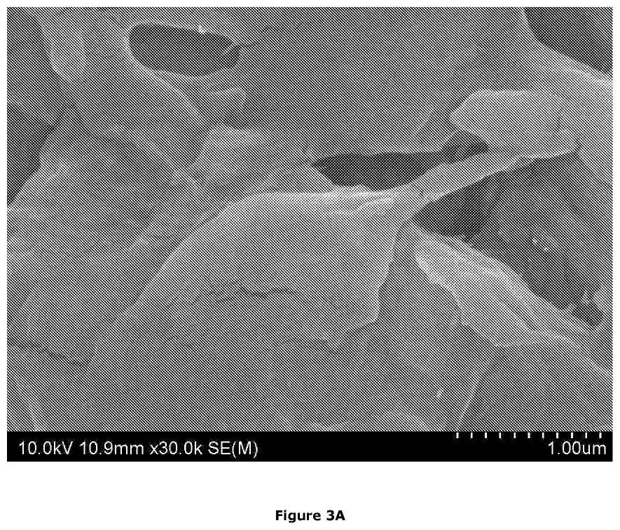

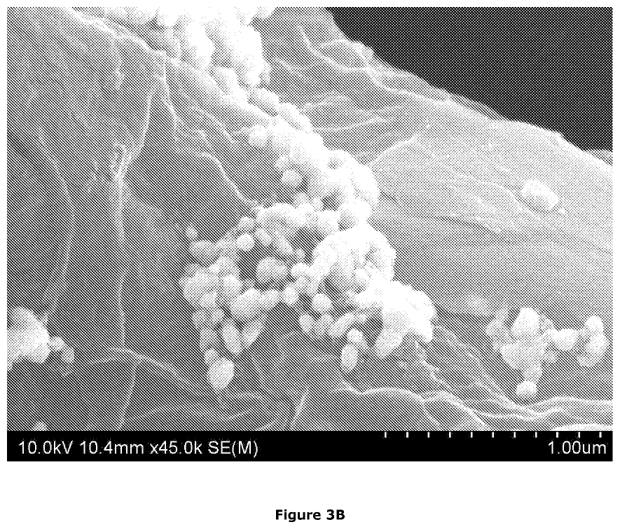

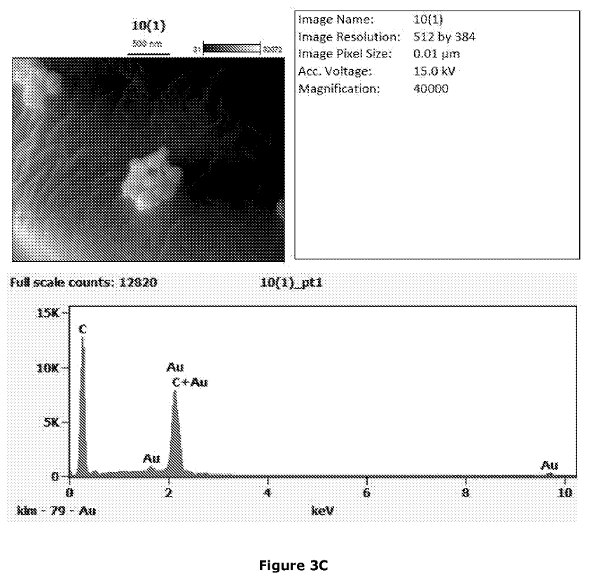

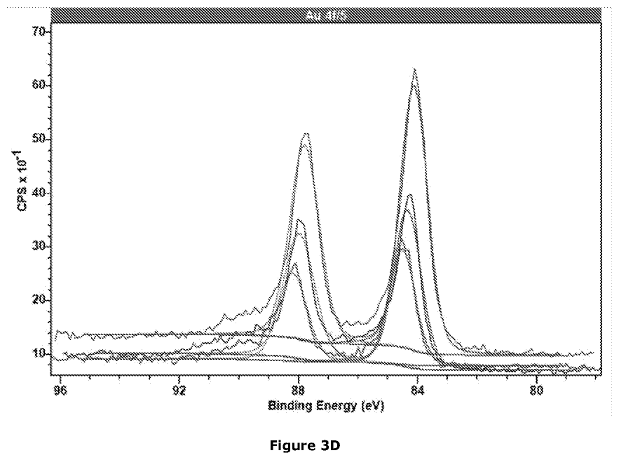

Analysis of biomass from the cellulose material generated in Example 10 above is presented in FIG. 3. In contrast to solely cellulose substrate (FIG. 3a), the gold laden cellulose biomass (FIG. 3b) contains nanoparticulate material as seen by SEM. This was confirmed to be gold by SEM-EDS (FIG. 3c), which also highlighted the purity of the particles by absence of any other signals in the spectrum. XPS spectra of these show they exist in the form of Au(0) determined by the two spin-orbit split signals at 84.2 eV (4f 7/2) and 87.8 eV (4f 5/2) (FIG. 3d).

The entire disclosures of all applications, patents and publications cited above and below, if any, are herein incorporated by reference.

Where in the foregoing description reference has been made to integers or components having known equivalents thereof, those integers are herein incorporated as if individually set forth.

It should be noted that various changes and modifications to the presently preferred examples described herein will be apparent to those skilled in the art. Such changes and modifications may be made without departing from the spirit and scope of the invention and without diminishing its attendant advantages. It is therefore intended that such changes and modifications be included within the present invention.

The invention may also be said broadly to consist in the parts, elements and features referred to or indicated in the specification of the application, individually or collectively, in any or all combinations of two or more of said parts, elements or features.

Aspects of the invention have been described by way of example only, and it should be appreciated that variations, modifications and additions may be made without departing from the scope of the invention, for example when present the invention as defined in the indicative claims. Furthermore, where known equivalents exist to specific features, such equivalents are incorporated as if specifically referred in this specification.

1. A method for selectively binding a target metal to a support material, wherein the method comprises
a) adding the support material to a solution containing dissolved ions of target metal; and
b) reducing the target metal ion such that the target metal binds to the support material using an amount of reducing agent with a reducing potential high/low enough to reduce target metal ion to target metal but not high/low enough to reduce non-target metal;
c) separating the support material from the solution; and
d) recovering the target metal from the support material.

2. A method of recovering one or more target metals from a solution, wherein the solution comprises dissolved metal ions of at least one target metal and dissolved metal ions of at least one non-target metal, the method comprising:
a) adding to the solution a support material and a reducing agent, wherein the reducing agent has a reducing potential effective to reduce at least one species of target metal ions to target metal but ineffective to reduce at least one species of non-target metal ions; and
b) maintaining the solution for a time and under conditions suitable to bind the at least one target metal to the support material to form a target metal-laden support material; and
c) separating the metal-laden support material from the solution; and
d) recovering the at least one target metal from the target metal-laden support material.

3. A method of recovering one or more target metals from a solution, wherein the solution comprises dissolved metal ions of at least one target metal and dissolved metal ions of at least one non-target metal, the method comprising:
a) adding to the solution a support material and a reducing agent, wherein the reducing agent has a reducing potential effective to reduce at least one species of non-target metal, and wherein the reducing agent is added in an amount insufficient to reduce all of said at least one species of non-target metal ions; and
b) maintaining the solution for a time and under conditions suitable to reduce the at least one target metal ions and to bind the at least one target metal to the support material to form a target metal-laden support material; and
c) separating the target metal-laden support material from the solution; and
d) recovering the at least one target metal from the target metal-laden support material.

4. The method of any one of claims 1 to 3, wherein the solution is formed by dissolution of a solid feedstock.

5. The method of any one of the preceding claims, wherein the addition of support material to the solution precedes the addition of reducing agent by a time sufficient to allow for dispersal of the support material in the solution.

6. The method of any one of the preceding claims, wherein the addition of reducing agent to the solution precedes the addition of support material.

7. The method of any one of the preceding claims, wherein the reducing agent has a reducing potential effective to reduce only one species of metal ions present in the solution to metal.

8. The method of any one of the preceding claims, wherein the reducing agent has a reducing potential effective to reduce only one species of the target metal ions present in the solution to target metal.

9. The method of any one of the preceding claims, wherein the reducing agent has a reducing potential effective to reduce only one species of the target metal ions present in the solution to target metal and ineffective in reducing all species of non-target metal ions present in the solution.

10. The method of any one of the preceding claims, wherein the reducing agent has a reducing potential effective to reduce at least one species of target metal ions present in the solution to target metal, but ineffective to reduce all species of non-target metal ions.

11. The method of any one of the preceding claims, wherein the method comprises after step b) the additional step of adding to the solution another reducing agent having a reducing potential effective to reduce at least one species of target metal ions still present in the solution to target metal.

12. The method of any one of the preceding claims, wherein the method comprises after step b) the additional step of adding to the solution another reducing agent having a reducing potential effective to reduce at least one species of target metal ions still present in solution to target metal, but ineffective to reduce at least one species of non-target metal ions.

13. The method of claim 3 wherein the reducing agent has a reducing potential effective to reduce at least one species of non-target metal ions present in the solution, and is added in an amount insufficient to reduce all of the non-target metal ions present.

14. The method of claim 3 or 13, wherein the reducing agent has a reducing potential effective to reduce at least one species of non-target metal ions present in the solution, but ineffective to reduce all species of non-target metal ions.

15. The method of claim 13 or 14 wherein the reducing agent has a reducing potential effective to reduce all species of non-target metal ions present in the solution to target metal, and is added in an amount insufficient to reduce all of the non-target metal ions present.

16. The method of any one of the preceding claims, wherein the method comprises after step b) the additional step of separating the target metal laden support material from the solution and adding the support material to a solution and reducing agent as set out in step (a).

17. The method of any one of the preceding claims, wherein the target metal-laden support material is separated from the solution by filtration.

18. The method of any one of the preceding claims, wherein the support material comprises, consists essentially of, or consists of cellulose or a cellulosic material, and/or the support material comprises, consists essentially of, or consists of non-cellular biomass, and/or the support material comprises, consists essentially of, or consists of non-microbial biomass.

19. The method of any one of the preceding claims, wherein the reducing agent is selected from the group consisting of organic acids, hydrazines, hydrides, borohydrides, and inorganic acids.

20. The method of claim 19, wherein the reducing agent comprises, consists essentially of, or consists of one or more inorganic acids or one or more organic acids.

21. The method of claim 20 wherein the reducing agent is selected from the group consisting of ascorbic acid or a salt thereof, citric acid or a salt thereof, formic acid or a salt thereof, lactic acid or a salt thereof, malic acid or a salt thereof, oxalic acid or a salt thereof, tartaric acid or a salt thereof, and uric acid or a salt thereof.

22. The method of any one of the preceding claims, wherein one of the target metals is selected from the group consisting of gold, palladium, platinum, and rhodium.

23. The method of claim 22 wherein one of the target metals is gold.

24. The method of any one of the preceding claims, wherein when one of the species of target metal ions is gold, the reducing agent is ascorbic acid or a salt thereof.

25. The method of any one of claims 4 to 24, wherein the method comprises the preliminary step of pre-processing the solid feedstock.

26. The method of any one of the preceding claims, wherein the solution is an aqueous solution containing more than 10 ppm of the target metal.

27. The method of any one of the preceding claims, wherein the barren aqueous solution contains less than 1 ppm of the target metal.

28. The method of any one of the preceding claims, wherein at least about 90% of the target metal is bound to the support material and/or recovered.

29. The method of any one of the preceding claims, wherein at least about 95%, or at least about 99%, of the target metal is bound to the support material and/or recovered.

30. The method of any one of the preceding claims, wherein the concentration factor of the target metal from the pregnant aqueous solution to the support material is greater than 100.

31. The method of any one of the preceding claims, wherein the concentration factor of the target metal from the pregnant aqueous solution to the support material is greater than 1000.

32. The method of any one of the preceding claims, wherein in the maintaining step the support material is in contact with the pregnant aqueous solution for between about 0.5 and 48 hours.

33. The method of any one of the preceding claims, wherein the recovery step comprises burning of the metal laden support material or chemical dissolution of the target metal/support material complex to release the target metal.

34. The method of any one of the preceding claims, wherein the pregnant solution comprises at least one further metal and the reducing agent preferentially reduces the target metal over the further metal, and the further metal(s) remains in the barren solution in the separating step.

35. The method of claim 34 wherein the target metal is bound to the support material over the further metal in the binding step such that the mass ratio of target metal to further metal on the support material increases by a factor of at least 2 when compared to the mass ratio in the pregnant solution.

36. The method of claim 34 or 35 wherein the further metal is selected from one or more of copper and nickel.

37. The method of any one of claims 4 to 36 wherein the solid feedstock comprises a solid material comprising less than 5% of target metal.

38. The method of any one of claims 3 to 37 wherein the solid feedstock is selected from the group consisting of an ore, a tailing, or e-waste.

39. The method of any one of claims 4 to 38 wherein the target metal is gold and the solid feedstock material is selected from the group consisting of e-waste, gold bearing ore, gold bearing sand, gold bearing clay and a combination of any two or more thereof.

40. The method of any one of the preceding claims, wherein the solution is formed by dissolution of a solid feedstock in a lixiviant.

41. The method of claim 40 wherein the lixiviant solution is a thiourea-based solution, or a thiosulphate-based solution, or a thiocyanate-based solution, or a cyanide-based solution, or a halogen-based solution, or an aqua regia-based solution.

42. The method of any one of the preceding claims wherein the pH of the solution prior to the recovery step is maintained within the range of from about 3 to about 10.

43. The method of any one of the preceding claims wherein at least a portion of the support material and/or the barren solution is reused in a further repeat of the method.

44. The method of claim 43 wherein one or more additional components are added to the barren solution such that it can act as a lixiviant.

45. The method of claim 44 wherein the one or more additional components are selected from one or more of thiourea, thiosulphate, thiocyanate, cyanide, a halogen, nitric acid, hydrochloric acid.

46. The method of claim 45 wherein the barren solution is treated with chlorine gas.

47. The method of any one of claims 43 to 46 wherein at least 25% of the barren solution is reused.

48. The method of any one of the previous claims wherein the method comprises a preliminary pre-processing step selected from the group consisting of chip removal; grinding, for example grinding to a preselected size; removal of certain density fractions; removal of one or more magnetic materials; a base metal leach; and any combination of two or more thereof.

49. The method of claim 48 wherein the pre-processing step removes at least a portion of non-target material from the feedstock.

50. The method of claim 49 wherein the non-target material includes one or more base metal(s).

51. A method of preparing a target metal laden cellulose material, the method comprising:
a) adding to a solution comprising dissolved metal ions of at least one target metal and dissolved metal ions of at least one non-target metal a filterable cellulose material and a reducing agent, wherein the reducing agent has a reducing potential effective to reduce at least one species of target metal ions to target metal but ineffective to reduce at least one species of non-target metal ions; and
b) maintaining the solution for a time and under conditions suitable to precipitate the at least one target metal to the cellulose material to form a target metal-laden cellulose material; and
c) separating the metal-laden cellulose material from the solution by filtration; and
d) recovering the target metal-laden cellulose material.

52. The method according to claim 51, wherein the target metal is gold.

53. A metal laden cellulose material prepared by the method as claimed in any preceding claim.

54. The metal laden cellulose material according to claim 53, wherein the metal is gold.

55. The metal laden cellulose material according to claim 54, wherein the gold is gold nanoparticles.
